(19) United States
(12) Patent Application Publication
(10) Pub. No.: US 2026/0188266 A1
(43) Pub. Date: Jul. 2, 2026

(54) Display Device, Controller, and Driving Method

(71) Applicant: LG Display Co., Ltd., Seoul (KR)

(72) Inventor: Jeongwon Lee, Paju-si (KR)

(21) Appl. No.: 19/330,143

(22) Filed: Sep. 16, 2025

(30) Foreign Application Priority Data
Dec. 30, 2024 (KR) 10-2024-0200290

(51) Int. Cl. G09G 3/3291; G09G 3/32

(52) U.S. Cl. CPC G09G 3/3291; G09G 3/32; G09G 2310/0275; G09G 2310/08; G09G 2330/021

(57) ABSTRACT

Embodiments of the disclosure relate to a display device, a controller, and a driving method and, more specifically, may provide a display device, a controller, and a driving method capable of reducing power consumption in a display panel area requiring no data transition by outputting a first data voltage to a first data line at a first driving timing, outputting a second data voltage to the first data line at a second driving timing, and outputting a third data voltage to the first data line at a third driving timing so that the second data voltage is the same as the first data voltage.

### CROSS-REFERENCE TO RELATED APPLICATION

This application claims priority from Republic of Korea Patent Application No. 10-2024-0200290, filed on Dec. 30, 2024, which is hereby incorporated by reference in its entirety.

### BACKGROUND

### Field

Embodiments of the disclosure relate to a display device, a controller, and a driving method.

### Description of Related Art

As the information society develops, demand for display devices for displaying images is increasing in various forms. Various display devices, such as liquid crystal display devices and organic light emitting display devices, are being utilized in recent years.

Further, the display device may provide a detection function to perform a function depending on the light of the ambient environment. To that end, the display device should have various electronic devices (optical electronic devices), such as detection sensors and image sensors (cameras).

Since the electronic device should receive light from the front of the display device, a transmissive area should be formed in the area where the electronic device is disposed.

In this case, since subpixels are not disposed in the transmissive area, data transition of signals output from the data of the display controller and data driving circuit may be unnecessary at the driving timing corresponding to the transmissive area. Such unnecessary data transitions may result in inefficient power consumption.

### SUMMARY

Embodiments of the disclosure may provide a display device, a controller, and a driving method that may prevent a data transition due to unnecessary signal output from the transmissive area of the optical area.

Embodiments of the disclosure may provide a low-power display device, controller, and driving method by reducing power consumption by preventing a data transition at the driving timing corresponding to the transmissive area of the optical area.

Embodiments of the disclosure may provide a display device, a controller, and a driving method capable of outputting the previous output data to the data line at the driving timing corresponding to the transmissive area where the optical electronic device is disposed.

Objects of embodiments of the disclosure are not limited to those set forth herein, and other unmentioned objects would be apparent to one of ordinary skill in the art from the following description.

In one embodiment, a display device comprises: a display panel including a data line, a first subpixel and a second subpixel that are connected to the data line, and a first light transmissive area that is disposed along the data line; and a data driving circuit configured to output a first data voltage having a first voltage level to the first subpixel via the data line at a first driving timing that corresponds to the first subpixel and output a second data voltage that has the first voltage level to the data line at a second driving timing that corresponds to the first light transmissive area.

In one embodiment, a display device comprises: a display panel including a data line, a first subpixel and a second subpixel that are connected to the data line, and a first light transmissive area that is disposed along the data line; a data driving circuit configured to output data voltages to the data line; and a timing controller configured to receive first input data and output first output data that is based on the first input data to the data driving circuit responsive to the first input data corresponding to the first subpixel, and receive second input data that is different from the first input data and output the first output data to the data driving circuit responsive to the second input data corresponding to the first light transmissive area.

In one embodiment, a method for driving a display device comprising a data line, a first subpixel and a second subpixel that are connected to the data line, and a first light transmissive area that is disposed along the data line, the method comprising: outputting a first data voltage having a first voltage level to the first subpixel via the data line at a first driving timing that corresponds to the first subpixel; and outputting a second data voltage that maintains the first voltage level to the data line at a second driving timing that corresponds to the first light transmissive area, wherein the second data voltage is not output to the first subpixel during the second driving timing.

In one embodiment, a display device comprises: a display panel including a data line, a plurality of subpixels connected to the data line, and a plurality of light transmissive areas that are disposed along the data line and are arranged in a same column as the plurality of subpixels; and a data driving circuit configured to output to the data line at a second driving timing that corresponds to a light transmissive area from the plurality of light transmissive areas, a data voltage that was previously output to a subpixel from the plurality of subpixels via the data line at a first driving timing that is prior to the second driving timing and the data voltage is not output to the subpixel at the second driving timing, wherein the subpixel is arranged closest to the light transmissive area amongst subpixels from the plurality of subpixels that are arranged before the light transmissive area in the same column.

According to embodiments of the disclosure, there may be provided a display device, a controller, and a driving method that may prevent a data transition due to unnecessary signal output from the transmissive area of the optical area.

According to embodiments of the disclosure, there may be provided a low-power display device, controller, and driving method by reducing power consumption by preventing a data transition at the driving timing corresponding to the transmissive area of the optical area.

According to embodiments of the disclosure, there may be provided a display device, a controller, and a driving method capable of outputting the previous output data to the data line at the driving timing corresponding to the transmissive area where the optical electronic device is disposed.

The effects of the disclosure are not limited to the foregoing objects, and other effects will be apparent to one of ordinary skill in the art from the following detailed description.

### BRIEF DESCRIPTION OF DRAWINGS

The disclosure will be more fully understood from the following detailed description and the accompanying drawings, which are provided for illustration only and are not intended to limit the disclosure.

FIG. 1 illustrates a system configuration of a display device and an arrangement of subpixels in two areas included in a display area according to embodiments of the disclosure;

FIG. 2 is a view illustrating a bending structure and a wiring structure in a planar structure of a display panel according to embodiments of the disclosure;

FIG. 3 is a view illustrating a configuration of a gate driving circuit in a display device according to embodiments of the disclosure;

FIG. 4 is a view illustrating a pixel circuit in a display device according to embodiments of the disclosure;

FIG. 5 is a view illustrating a cross-sectional structure taken along dashed line A-A′ of the display panel of FIG. 2 according to embodiments of the disclosure;

FIG. 6 is a cross-sectional view taken along dashed line B-B′ of the optical area of FIG. 1 according to embodiments of the disclosure;

FIG. 7 is a view illustrating a configuration of a transition reducer circuit to prevent an unnecessary data transition in a transmissive area disposed on a display panel according to embodiments of the disclosure;

FIG. 8 is a table representing output data according to control signals output from a control signal output unit according to embodiments of the disclosure;

FIG. 9 illustrates a table and a graph of input data and output data corresponding to each row in area A which is a portion of the normal area of FIG. 1 according to embodiments of the disclosure;

FIG. 10 illustrates a table and a graph of input data and output data corresponding to each row in area B which is a portion of the optical area of FIG. 1 according to embodiments of the disclosure;

FIG. 11 is a view illustrating another arrangement of a subpixel and an emission area in area B of the optical area of FIG. 1 according to embodiments of the disclosure;

FIG. 12 illustrates a table and a graph of input/output signals related to a third column in area B which is a portion of the optical area of FIG. 11 according to embodiments of the disclosure;

FIG. 13 is a view illustrating another arrangement of a subpixel and an emission area in area B of the optical area of FIG. 1 according to embodiments of the disclosure;

FIGS. 14 and 15 illustrate a table and a graph of input/output signals related to a first column and a third column in area B which is a portion of the optical area of FIG. 13 according to embodiments of the disclosure; and

FIG. 16 is a flowchart illustrating a driving method for a first column of the optical area of FIG. 1 according to embodiments of the disclosure.

### DETAILED DESCRIPTION

In the following description of examples or embodiments of the disclosure, reference will be made to the accompanying drawings in which it is shown by way of illustration specific examples or embodiments that can be implemented, and in which the same reference numerals and signs can be used to designate the same or like components even when they are shown in different accompanying drawings from one another. Further, in the following description of examples or embodiments of the disclosure, detailed descriptions of well-known functions and components incorporated herein will be omitted when it is determined that the description may make the subject matter in some embodiments of the disclosure rather unclear. The terms such as “including”, “having”, “containing”, “constituting” “make up of”, and “formed of” used herein are generally intended to allow other components to be added unless the terms are used with the term “only”. As used herein, singular forms are intended to include plural forms unless the context clearly indicates otherwise.

Terms, such as “first”, “second”, “A”, “B”, “(A)”, or “(B)” may be used herein to describe elements of the disclosure. Each of these terms is not used to define essence, order, sequence, or number of elements etc., but is used merely to distinguish the corresponding element from other elements.

When it is mentioned that a first element “is connected or coupled to”, “contacts or overlaps” etc. a second element, it should be interpreted that, not only can the first element “be directly connected or coupled to” or “directly contact or overlap” the second element, but a third element can also be “interposed” between the first and second elements, or the first and second elements can “be connected or coupled to”, “contact or overlap”, etc. each other via a fourth element. Here, the second element may be included in at least one of two or more elements that “are connected or coupled to”, “contact or overlap”, etc. each other.

When time relative terms, such as “after,” “subsequent to,” “next,” “before,” and the like, are used to describe processes or operations of elements or configurations, or flows or steps in operating, processing, manufacturing methods, these terms may be used to describe non-consecutive or non-sequential processes or operations unless the term “directly” or “immediately” is used together.

In addition, when any dimensions, relative sizes etc. are mentioned, it should be considered that numerical values for an elements or features, or corresponding information (e.g., level, range, etc.) include a tolerance or error range that may be caused by various factors (e.g., process factors, internal or external impact, noise, etc.) even when a relevant description is not specified. Further, the term “may” fully encompasses all the meanings of the term “can”.

Hereinafter, various embodiments of the disclosure are described in detail with reference to the accompanying drawings.

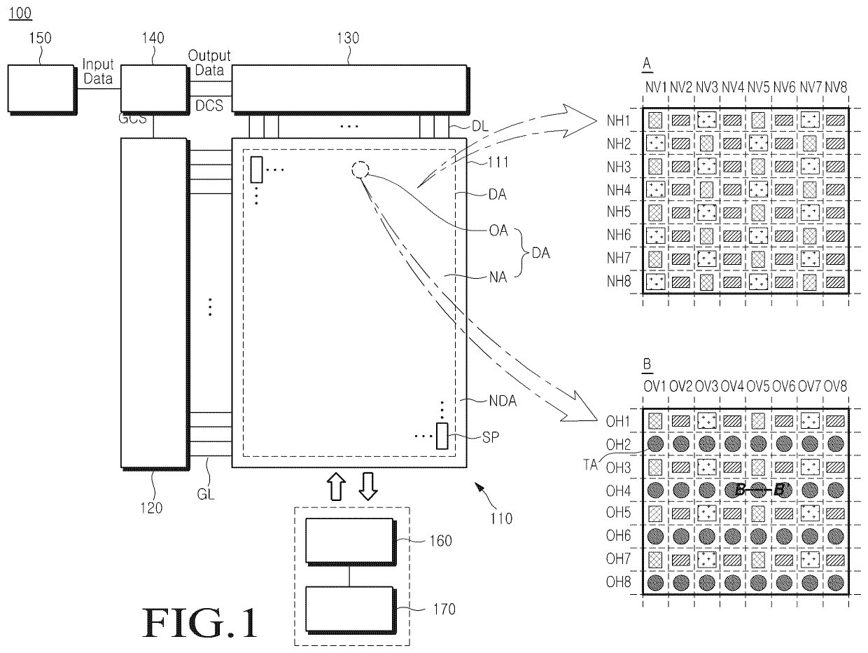

FIG. 1 illustrates a system configuration of a display device 100 and an arrangement of subpixels SP in two areas NA and OA included in a display area DA according to embodiments of the disclosure.

Referring to FIG. 1, a display device 100 may include a display panel 110 and display driving circuits, as components for displaying images.

Referring to FIG. 1, the display device 100 according to embodiments of the disclosure may include a display panel 110 for displaying an image and an optical electronic device (not illustrated).

The display driving circuits are circuits for driving the display panel 110 and may include a data driving circuit 130, a gate driving circuit 120, and a display controller 140.

The display panel 110 may include a display area DA in which images are displayed and a non-display area NDA in which no image is displayed. A plurality of subpixels may be disposed in the display area DA, and various signal lines for driving the plurality of subpixels may be disposed in the display area AA. The non-display area NDA may be an outer area of the display area DA and be referred to as a bezel area. The whole or part of the non-display area NDA may be an area visible from the front surface of the display device 100 or an area that is bent and not visible from the front surface of the display device 100. In the non-display area NDA, various signal lines may be disposed, and various driving circuits may be connected thereto. The non-display area NDA may be bent to be invisible from the front or may be covered by a case (not shown).

Referring to FIG. 1, in the display device 100 according to embodiments of the disclosure, an optical electronic device (not illustrated) is an electronic component positioned under the display panel 110 (opposite to the viewing surface).

Light may enter the front surface (viewing surface) of the display panel 110 and pass through the display panel 110 to be transferred to the optical electronic device positioned under the display panel 110 (opposite to the viewing surface).

The optical electronic device may be a device that receives light transmitted through the display panel 110 and performs a predetermined function according to the received light. For example, the optical electronic device may include a capturing device such as a camera (image sensor).

Referring to FIG. 1, in the display panel 110 according to embodiments of the disclosure, the display area DA may include a normal area NA and an optical area OA.

Referring to FIG. 1, the optical area OA may be an area overlapping the optical electronic device.

According to the example of FIG. 1, the display area DA may include a normal area NA and an optical area OA. Here, at least a portion of the optical area OA may overlap the optical electronic device.

Further, the optical area OA should have both an image display structure and a light transmission structure. In other words, since the optical area OA is a partial area of the display area DA, subpixels for image display should be disposed in the optical area OA. Further, a light transmission structure for transmitting light (e.g., external light) to the optical electronic device should be formed in the optical area OA.

The optical electronic device is a device that requires light reception, but is positioned behind the display panel 110 (below, opposite to the viewing surface) to receive light transmitted through the display panel 110.

The optical electronic device is not exposed on the front surface (viewing surface) of the display panel 110. Accordingly, when the user views the front surface of the display device 100, the optical electronic device is not visible to the user.

For example, the optical electronic device may be a camera or an infrared sensor. The type of optical electronic device is not limited thereto.

In the following, for convenience of description, it is exemplified that the optical electronic device is a camera. The camera may be a camera lens or an image sensor.

When the optical electronic device is a camera, the camera may be a front camera that is positioned behind (below) the display panel 110 but captures forward of the display panel 110. Accordingly, the user may take a photograph through the camera invisible to the viewing surface while viewing the viewing surface of the display panel 110.

The normal area NA and the optical area OA included in the display area DA are areas that may display images, but the normal area NA is an area that does not require a light transmission structure to be formed, and the optical area OA is an area that requires a light transmission structure to be formed.

For example, the number of subpixels per unit area in the optical area OA may be smaller than the number of subpixels per unit area in the normal area NA. In other words, the resolution of the optical area OA may be lower than the resolution of the normal area NA. For example, the number of subpixels per unit area may be the unit for measuring the resolution, and may also be referred to as pixels per inch (PPI), which means the number of pixels in one inch.

For example, the number of subpixels per unit area in the optical area OA may be smaller than the number of subpixels per unit area in the normal area NA.

Accordingly, the display device 100 according to embodiments of the disclosure does not require a notch or a hole for the optical electronic device to be formed in the display panel 110, thereby preventing a reduction in the display area DA.

Thus, as there is no need to form a notch or a hole for exposure of the optical electronic device in the display panel 110, the size of the bezel area may be reduced, and design restrictions may be freed, thereby increasing the degree of freedom in design.

In the display device 100 according to embodiments of the disclosure, although the optical electronic device is positioned to be hidden behind the display panel 110, the optical electronic device should be able to normally perform predetermined functions by normally receiving light.

Further, in the display device 100 according to embodiments of the disclosure, although the optical electronic device is positioned to be hidden behind the display panel 110 and is positioned to overlap the display area DA, the optical area OA overlapping the optical electronic device in the display area DA should be capable of normal image display.

The display device 100 according to embodiments of the disclosure may be a self-emission display device in which the display panel 110 emits light by itself. However, the display device 100 according to embodiments of the disclosure is not limited to a self-luminous display device. When the display device 100 according to the embodiments of the disclosure is a self-emission display device, each of the plurality of subpixels SP may include a light emitting element. For example, the display device 100 according to embodiments of the disclosure may be an organic light emitting diode display in which the light emitting element is implemented as an organic light emitting diode (OLED). As another example, the display device 100 according to embodiments of the disclosure may be an inorganic light emitting display device in which the light emitting element is implemented as an inorganic material-based light emitting diode. As another example, the display device 100 according to embodiments of the disclosure may be a quantum dot display device in which the light emitting element is implemented as a quantum dot which is self-emission semiconductor crystal.

The structure of each of the plurality of subpixels SP may vary according to the type of the display device 100. For example, when the display device 100 is a self-emission display device in which the subpixels SP emit light by themselves, each subpixel SP may include a light emitting element that emits light by itself, one or more transistors, and one or more capacitors.

For example, various types of signal lines may include a plurality of data lines DL transferring data signals (also referred to as data voltages or image signals) and a plurality of gate lines GL transferring gate signals (also referred to as scan signals).

The plurality of data lines DL and the plurality of gate lines GL may cross each other. Each of the plurality of data lines DL may be disposed while extending in a first direction. Each of the plurality of gate lines GL may be disposed while extending in a second direction. Here, the first direction may be a column direction and the second direction may be a row direction. The first direction may be the row direction, and the second direction may be the column direction.

The data driving circuit 130 is a circuit for driving the plurality of data lines DL, and may output data signals to the plurality of data lines DL. The gate driving circuit 120 is a circuit for driving the plurality of gate lines GL, and may output gate signals to the plurality of gate lines GL.

The display controller 140 is a device for controlling the data driving circuit 130 and the gate driving circuit 120 and may control driving timings for the plurality of data lines DL and driving timings for the plurality of gate lines GL.

The display controller 140 may supply a data driving control signal DCS to the data driving circuit 130 to control the data driving circuit 130 and may supply a gate driving control signal GCS to the gate driving circuit 120 to control the gate driving circuit 120.

The display controller 140 may receive input image data Input Data from the host system 150 and supply image data Output Data to the data driving circuit 130 based on the input image data Input Data.

The data driving circuit 130 may receive digital image data Output Data from the display controller 140 and may convert the received image data Output Data into analog data signals and output the analog data signals to the plurality of data lines DL.

The gate driving circuit 120 may receive a first gate voltage corresponding to a turn-on level voltage and a second gate voltage corresponding to a turn-off level voltage, along with various gate driving control signals GCS, generate gate signals, and supply the generated gate signals to the plurality of gate lines GL.

For example, the data driving circuit 130 may be connected with the display panel 110 by a tape automated bonding (TAB) method or connected to a bonding pad of the display panel 110 by a chip on glass (COG) or chip on panel (COP) method or may be implemented by a chip on film (COF) method and connected with the display panel 110.

The gate driving circuit 120 may be connected with the display panel 110 by TAB method or connected to a bonding pad of the display panel 110 by a COG or COP method or may be connected with the display panel 110 according to a COF method. Alternatively, the gate driving circuit 120 may be formed in a gate in panel (GIP) type, in the non-display area NDA of the display panel 110. The gate driving circuit 120 may be disposed on the substrate or may be connected to the substrate. In other words, the gate driving circuit 130 that is of a GIP type may be disposed in the non-display area NDA of the substrate. The gate driving circuit 120 that is of a chip-on-glass (COG) type or chip-on-film (COF) type may be connected to the substrate.

Meanwhile, at least one of the data driving circuit 130 and the gate driving circuit 120 may be disposed in the display area DA of the display panel 110. For example, at least one of the data driving circuit 130 and the gate driving circuit 120 may be disposed not to overlap (e.g., non-overlapping) the subpixels SP or to overlap all or some of the subpixels SP.

The data driving circuit 130 and the gate driving circuit 120 may be connected to one side (e.g., an upper or lower side) of the display panel 110. Depending on the driving scheme or the panel design scheme, data driving circuits 130 and gate driving circuits 120 may be connected with both the sides (e.g., both the upper and lower sides) of the display panel 110, or two or more of the four sides of the display panel 110.

The display controller 140 may be implemented as a separate component from the data driving circuit 130, or the display controller 140 and the data driving circuit 130 may be integrated into an integrated circuit (IC).

The display controller 140 may be a timing controller used in typical display technology, a control device that may perform other control functions as well as the functions of the timing controller, or a control device other than the timing controller, or may be a circuit in the control device. The display controller 140 may be implemented as various circuits or electronic components, such as an integrated circuit (IC), a field programmable gate array (FPGA), an application specific integrated circuit (ASIC), or a processor.

The display controller 140 may be mounted on a printed circuit board or a flexible printed circuit and may be electrically connected with the data driving circuit 130 and the gate driving circuit 120 through the printed circuit board or the flexible printed circuit.

The display controller 140 may transmit/receive signals to/from the data driving circuit 130 according to one or more predetermined interfaces. The interface may include, e.g., a low voltage differential signaling (LVDS) interface, an embedded clock point-point interface (EPI) interface, and a serial peripheral interface (SPI).

To provide a touch sensing function as well as an image display function, the display device 100 according to embodiments of the disclosure may include a touch sensor and a touch sensing circuit that senses the touch sensor to detect whether a touch occurs by a touch object, such as a finger or pen, or the position of the touch.

The touch sensing circuit may include a touch driving circuit 160 that drives and senses the touch sensor and generates and outputs touch sensing data and a touch controller 170 that may detect an occurrence of a touch or the position of the touch using touch sensing data.

The touch sensor may include a plurality of touch electrodes. The touch sensor may further include a plurality of touch lines for electrically connecting the plurality of touch electrodes and the touch driving circuit 160.

The touch sensor may be present in a touch panel form outside the display panel 110 or may be present inside the display panel 110. When the touch panel, in the form of a touch panel, exists outside the display panel 110, the touch panel is referred to as an external type. When the touch sensor is of the external type, the touch panel and the display panel 110 may be separately manufactured or may be combined during an assembly process. The external-type touch panel may include a touch panel substrate and a plurality of touch electrodes on the touch panel substrate.

When the touch sensor is present inside the display panel 110, the touch sensor may be formed on the substrate 111, together with signal lines and electrodes related to display driving, during the manufacturing process of the display panel 110.

The touch driving circuit 160 may supply a touch driving signal to at least one of the plurality of touch electrodes and may sense at least one of the plurality of touch electrodes to generate touch sensing data.

The touch driving circuit 160 and the touch controller 170 included in the touch sensing circuit may be implemented as separate devices or as a single device. The touch driving circuit 160 and the data driving circuit 130 may be implemented as separate devices or as a single device.

The display device 100 may further include a power supply circuit for supplying various types of power to the display driver integrated circuit and/or the touch sensing circuit.

The display device 100 according to embodiments of the disclosure may be a mobile terminal, such as a smart phone or a tablet, or a monitor or television (TV) in various sizes but, without limited thereto, may be a display in various types and various sizes capable of displaying information or images.

Meanwhile, as described above, the display area DA in the display panel 110 may include the normal area NA and one or more optical areas OA. The normal area NA and the optical area OA are areas capable of displaying an image. However, the normal area NA is an area where a light transmission structure is not required to be formed, and the optical area OA is an area in which a light transmission structure is to be formed.

As described above, the display area DA in the display panel 110 may include one or more optical areas OA together with the normal area NA, but for convenience of description, it is assumed that the display area DA includes only one optical area OA.

Referring to FIG. 1, a plurality of subpixels SP may be disposed according to a matrix in each of area A of the normal area NA and area B of the optical area OA included in the display area DA.

For example, the plurality of subpixels SP may include a red subpixel Red SP emitting red light, a green subpixel Green SP emitting green light, and a blue subpixel Blue SP emitting blue light.

Accordingly, each of the normal area NA and the optical area OA may include emission areas EA of the red subpixels Red SP, emission areas EA of the green subpixels Green SP, and emission areas EA of the blue subpixels Blue SP.

Referring to FIG. 1, the normal area NA may not include a light transmission structure, but may include light emission areas EA.

However, the optical area OA includes the emission areas EA and a light transmission structure. Thus, the optical area OA may include emission areas EA and a transmissive area TA.

Referring to FIG. 1, a plurality of emission areas EA may be disposed according to the matrix NH1, NH2, NH3, NH4, NH5, NH6, NH7, NH8, NV1, NV2, NV3, NV4, NV5, NV6, NV7, and NV8 in area A included in the normal area NA. Further, a plurality of emission areas EA and transmissive areas TA may be disposed according to the matrix in area B included in the optical area OA.

Since the optical area OA includes the transmissive area TA, the optical area OA is an area through which light may be transmitted.

Referring to FIG. 1, a scan line SCL which is a type of gate line GL may be connected to each subpixel SP row (NH1, NH2, . . . , NH8) of the normal area NA. Further, a scan line SCL which is a type of gate line GL may correspond to each subpixel SP row (OH1, OH2, . . . , OH8) of the optical area OA.

Hereinafter, for description of the disclosure, the scan line SCL corresponding to the first row OH1 of the optical area OA may be referred to as a first line (not illustrated). Similarly, the scan line SCL corresponding to the second row OH2 of the optical area OA may be referred to as a second line (not illustrated). The scan line SCL corresponding to the third row OH3 of the optical area OA may be referred to as a third line (not illustrated). The scan line SCL corresponding to the fourth row OH4 of the optical area OA may be referred to as a fourth line (not illustrated).

The first line, the second line, the third line, and the fourth line may be scan lines SCL connected to the subpixels SP disposed in the corresponding column of the subpixel SP matrix among the plurality of scan lines SCL disposed on one display panel 110 for convenience of description. However, this is merely an example, and in practice, scan lines may be disposed in various examples. Hereinafter, for convenience of description, it is assumed that each of the scan lines SCL may be connected to each column disposed on the display panel 110 and all of the of the subpixels SP.

The first line, the second line, the third line, and the fourth line may be disposed in successive rows. In other words, the second line may be disposed between the first line and the third line. The third line may be disposed between the second line and the fourth line.

The plurality of subpixels SP may be disposed in each column of the same line in the first line and the third line. The subpixel SP may not be disposed in the second line and the fourth line in the optical area OA. In the second line and the fourth line, a transmissive area TA rather than the subpixel SP may be disposed in an area overlapping the optical area OA.

Referring to FIG. 1, the data line DL may be connected to each subpixel column NV1, NV2, . . . , NV8 of the normal area NA. Further, the data DL may be connected to each subpixel SP column OV1, OV2, . . . , OV8 of the optical area OA.

Hereinafter, for convenience of description, the data line DL corresponding to the first column OV1 of the optical area OA may be referred to as a first data line (not illustrated). Similarly, the data line DL corresponding to the second column OV2 of the optical area OA may be referred to as a second data line (not illustrated). The data line DL corresponding to the third column OV3 of the optical area OA may be referred to as a third data line (not illustrated). The data line DL corresponding to the fourth column OV4 of the optical area OA may be referred to as a fourth data line (not illustrated).

The first data line, the second data line, the third data line, and the fourth data line may be disposed in successive columns. In other words, the second data line may be disposed between the first data line and the third data line. The third data line may be disposed between the second data line and the fourth data line.

The subpixel SP and the transmissive area TA may be disposed to correspond to each data line DL disposed in the optical area OA. For example, a first subpixel (not illustrated) may be connected to and disposed at the point where the first data line and the first line intersect. The first subpixel may be overlappingly disposed at the position corresponding to the emission area EA of SP1 of the first subpixel, and is not illustrated in the drawings for convenience. Further, the third subpixel (not illustrated) may be connected to and disposed at the point where the first data line and the third line intersect. The third subpixel may be overlappingly disposed at the position corresponding to the emission area EA of SP3 of the third subpixel, and is not illustrated in the drawings for convenience.

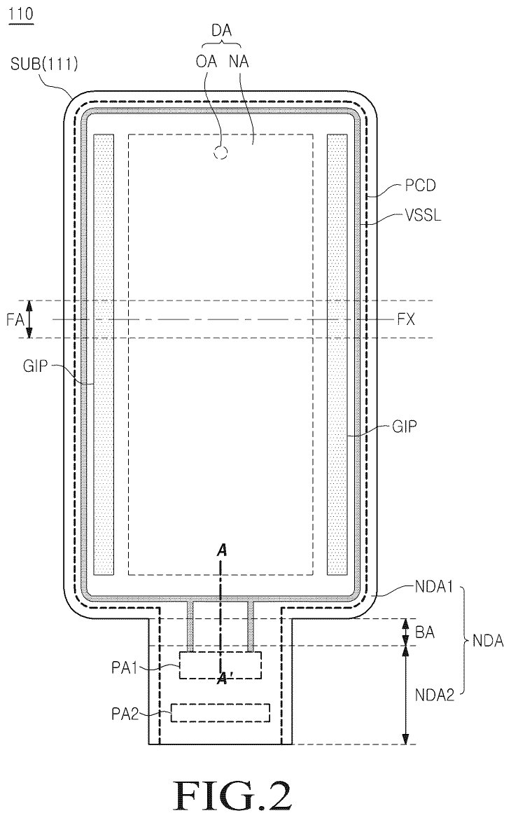

FIG. 2 is a view illustrating a bending structure and a wiring structure in a planar structure of a display panel 110 according to embodiments of the disclosure.

Referring to FIG. 2, the display area DA and the non-display area NDA included in the display panel 110 may be the same as the display area DA and the non-display area NDA described above with reference to FIG. 1. Further, the display area DA may include an optical area OA and a normal area NA as described above with reference to FIG. 1.

In the display device 100 according to embodiments of the disclosure, the substrate 111 may be a flexible substrate capable of bending. In the disclosure, “bending” may have a meaning equivalent to “folding” or “flexible.”

The display panel 110 may be included in a flexible display device 100 capable of maintaining display performance even when bent like paper. In this case, the display panel 110 may include at least one folding area FA that is bent with respect to the folding axis FX. The folding area FA is an area where the flexible display device 100 may be bent, and may be bent at a specific curvature with respect to the folding axis FX.

Although FIG. 2 illustrates that the folding axis FX is disposed to cross the center of the display panel 110, the position and number of folding axes FX may be variously changed. Likewise, the folding area FA is not limited thereto and may be variously changed.

The non-display area NDA may include a first non-display area NDA1, a bending area BA, and a second non-display area NDA2.

The first non-display area NDA1 may be positioned around the display area DA, and may be an area closest to the display area DA among the first non-display area NDA1, the bending area BA, and the second non-display area NDA2.

The second non-display area NDA2 may include pad areas PA1 and PA2 where various pads are disposed, and may be an area farthest from the display area DA among the first non-display area NDA1, the bending area BA, and the second non-display area NDA2.

The bending area BA is an area where the substrate 111 is bent, and may be an area positioned between the first non-display area NDA1 and the second non-display area NDA2.

A plurality of subpixels SP may be disposed in the display area DA. The non-display area NDA may include a gate in panel (GIP) area where a GIP-type gate driving circuit is formed, a bending area BA where various lines pass and a data driving circuit is electrically connected, and a second non-display area NDA2.

As described above, the substrates (SUB) 111 may include a bending area BA that is bent and folded, and the bending area BA may be folded to be positioned on the lower surface of the unfolded portion. The bending area BA is a partial area of the non-display area NDA, and may be positioned in the driving circuit area to which the data driving circuit is electrically connected and between the driving circuit area and the display area DA.

In FIG. 1, according to the structure of the subpixel SP, for driving the subpixel SP, a plurality of driving voltage lines DVL for supplying the driving voltage VDD to the subpixel SP and one or more base voltage lines VSSL for applying the base voltage VSS to the common electrode CE of the light emitting element ED in each subpixel SP may be further disposed on the substrates (SUB) 111.

Referring to FIG. 2, e.g., the plurality of driving voltage lines DVL may be disposed in the column direction, but the disclosure is not limited thereto. In order to efficiently transfer the driving voltage VDD to the plurality of driving voltage lines DVL, a driving voltage pattern integrally or electrically connected to the plurality of driving voltage lines DVL may be disposed in the non-display area NDA.

The plurality of driving voltage lines DVL may electrically connect the bending area BA to the data driving circuit or the printed circuit board connected to the pad areas PA1 and PA2 through the driving voltage pattern.

One or more base voltage lines VSSL may be disposed in the non-display area NDA to surround an outer area of the display area DA for efficient transfer of the base voltage VSS. Further, one or more base voltage lines VSSL may be electrically connected to the data driving circuit or the printed circuit board connected to the driving circuit area past the bending area BA.

A crack prevention pattern PCD may be formed on the substrates (SUB) 111. The crack prevention pattern PCD may be formed outside the base voltage line VSSL in the non-display area NDA, but the disclosure is not limited thereto.

For example, the crack prevention pattern PCD is a pattern for preventing cracks in lines passing through the substrate SUB 111, and may be formed in a zigzag pattern, but the disclosure is not limited thereto.

For example, when the bending area BA is bent, some of the signal lines passing through the bending area BA may be cracked (electrically opened) or short-circuited with neighboring signal lines. In this case, an accurate signal may not be transferred through a signal line that is cracked (opened) or short-circuited, and thus a problem with display driving or an image display may not be properly performed, and thus image quality may be greatly decreased. Thus, to prevent such issues, the crack prevention pattern PCD may be disposed.

Meanwhile, in the display device 100 according to embodiments of the disclosure, the gate driving circuit 120 may be configured in various examples.

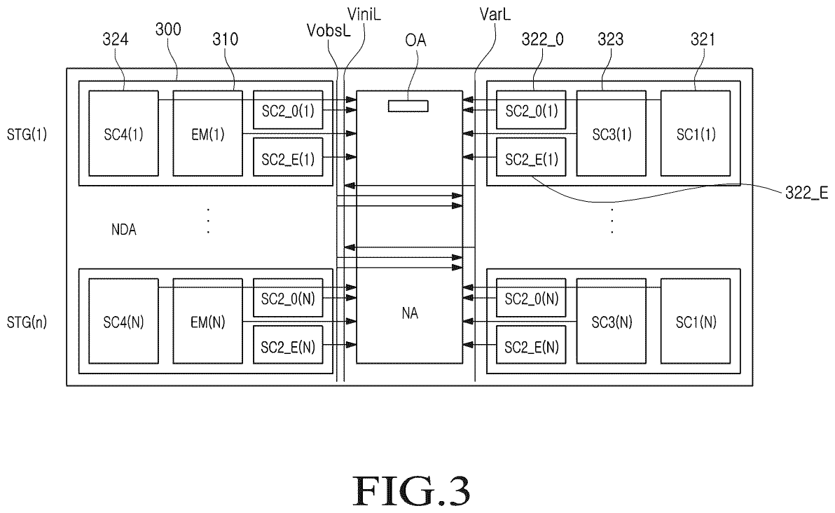

FIG. 3 is a view illustrating a configuration of a gate driving circuit 120 a display device 100 according to embodiments of the disclosure.

Referring to FIG. 3, the gate driving circuit 130 includes an emission control signal driver 310 and a scan driver 320. The scan driver 320 may include a first scan driver to a fourth scan driver 321 and 322. Further, each second scan driver 322 may include an odd-numbered second scan driver 322_O and an even-numbered second scan driver 322_E.

In the gate driving circuit 130, shift registers may be symmetrically configured on two opposite sides of the display area DA. Further, the shift register of the gate driving circuit 130, on one side of the display area DA, may include a second scan driver 322_O, 322_E, a fourth scan driver 324, and an emission control signal driver 310, and the shift register on the other side of the display area DA may include a first scan driver 321, a second scan driver 322_O, 322_E, and a third scan driver 323. However, the disclosure is not limited thereto, and the emission control signal driver 310 and the first to fourth scan drivers 321, 322, 323, and 324 may be disposed differently according to embodiments.

The stages STG1 to STGn of the shift register, respectively, may include first scan signal generators SC1(1) to SC1(n), second scan signal generators SC2_O(1) to SC2_O(n), SC2_E(1) to SC2_E(n), third scan signal generators SC3(1) to SC3(n), fourth scan signal generators SC4(1) to SC4(n), and emission control signal generators EM(1) to EM(n).

The first scan signal generators SC1(1) to SC1(n) output the first scan signals SC1(1) to SC1(n) through the first scan lines SCL1 of the display panel 100. The second scan signal generators SC2(1) to SC2(n) output the second scan signals SC2(1) to SC2(n) through the second scan lines SCL2 of the display panel 100. The third scan signal generators SC3(1) to SC3(n) output the third scan signals SC3(1) to SC3(n) through the third scan lines SCL3 of the display panel 100. The fourth scan signal generators SC4(1) to SC4(n) output the fourth scan signals SC4(1) to SC4(n) through the fourth scan lines SCL4 of the display panel 100. The emission control signal generating units EM(1) to EM(n) output emission control signals EM(1) to EM(n) through the emission control lines EML of the display panel 100.

The first scan signals SC1(1) to SC1(n) may be used as signals for driving an Ath transistor (e.g., a compensation transistor) included in the pixel circuit. The second scan signals SC2(1) to SC2(n) may be used as signals for driving a Bth transistor (e.g., a data supply transistor) included in the pixel circuit. The third scan signals SC3(1) to SC3(n) may be used as signals for driving a Cth transistor (e.g., a bias transistor) included in the pixel circuit. The fourth scan signals SC4(1) to SC4(n) may be used as signals for driving a Dth transistor (e.g., an initialization transistor) included in the pixel circuit. The emission control signals EM(1) to EM(n) may be used as signals for driving an Eth transistor (e.g., emission control transistor, etc.) included in the pixel circuit. For example, if the emission control transistors of the pixels are controlled using the emission control signals EM(1) to EM(n), the emission time of the light emitting element is varied.

Referring to FIG. 3, a bias voltage bus line VobsL, a first initialization voltage bus line VarL, and a second initialization voltage bus line ViniL may be disposed between the gate driving circuit 130 and the display area DA.

The bias voltage bus line VobsL, the first initialization voltage bus line VarL, and the second initialization voltage bus line ViniL may supply the bias voltage Vobs, the first initialization voltage Var, and the second initialization voltage Vini, respectively, from the power supply unit (not illustrated) to the pixel circuit.

In the drawings, the bias voltage bus line VobsL, the second initialization voltage bus line VarL, and the second initialization voltage bus line ViniL are shown as being positioned on one side of the left or right side of the display area DA but, without limitations thereto, may be positioned on two opposite sides or, even when positioned on one side, the position is not limited to the left or right side.

An optical area OA may be disposed in the display area DA as described above in connection with FIG. 1.

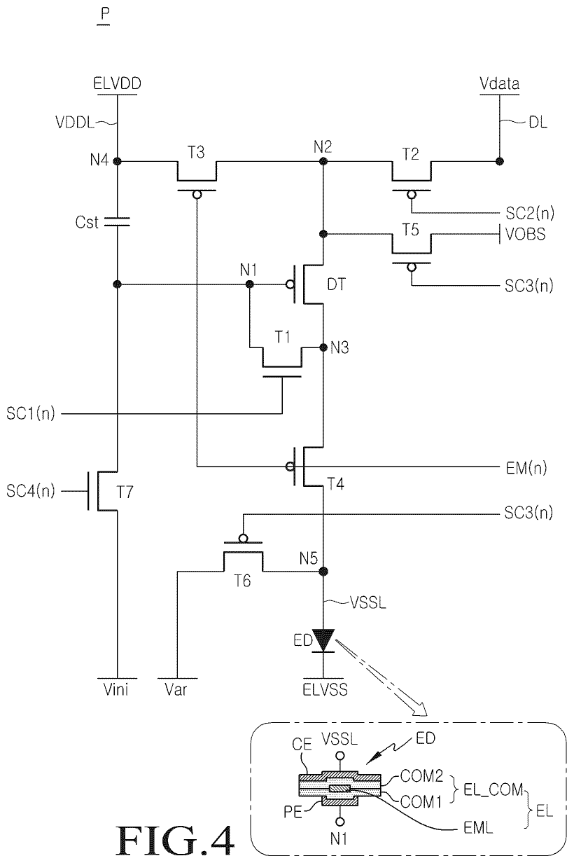

FIG. 4 is a view illustrating a pixel circuit in a display device 100 according to embodiments of the disclosure.

FIG. 4 merely illustrates a pixel circuit as an example for description, and embodiments of the disclosure are not limited as long as it has a structure that may control light emission of the light emitting element ED by applying a light emission signal EM(n). For example, the pixel circuit may include an additional scan signal, a switching thin film transistor connected thereto, and a switching thin film transistor to which an additional initialization voltage is applied, and the connection relationship of the switching elements and connection positions of the capacitors may be varied. Hereinafter, for convenience of description, a display device having the pixel circuit structure of FIG. 4 is described.

Referring to FIG. 4, each of the plurality of pixels P may include a pixel circuit having a driving transistor DT and a light emitting element ED connected to the pixel circuit.

The light emitting element ED may include a pixel electrode PE, an intermediate layer EL, and a common electrode CE. The intermediate layer EL may be disposed between the pixel electrode PE and the common electrode CE.

For example, the pixel electrode PE may be an electrode disposed in each subpixel SP, and the common electrode CE may be an electrode commonly disposed in all the subpixels SP. For example, the pixel electrode PE may be an anode, and the common electrode CE may be a cathode. As another example, the pixel electrode PE may be a cathode, and the common electrode CE may be an anode. For convenience of description, an example is described in which the pixel electrode PE is an anode, and the common electrode CE is a cathode.

When the light emitting element ED is an organic light emitting element, the intermediate layer EL may include a light emitting layer EML, a first common intermediate layer COM1 between the pixel electrode PE and the light emitting layer EML, and a second common intermediate layer COM2 between the light emitting layer EML and the common electrode CE. The first common intermediate layer COM1 and the second common intermediate layer COM2 may be collectively referred to as a common intermediate layer EL_COM.

The light emitting layer EML may be disposed for each subpixel SP or may be disposed commonly over a plurality of subpixels SP. The common intermediate layer EL_COM may be commonly disposed over the plurality of subpixels SP, but embodiments of the disclosure are not limited thereto.

In other words, the light emitting layer EML may be disposed for each emission area or disposed commonly across a plurality of emission areas. The common intermediate layer EL_COM may be commonly disposed across a plurality of emission areas and non-emission areas, but embodiments of the disclosure are not limited thereto.

For example, the first common intermediate layer COM1 may include a hole injection layer HIL, an electron blocking layer EBL, and a hole transport layer HTL, but embodiments of the disclosure are not limited thereto. The second common intermediate layer COM2 may include an electron transport layer ETL, a hole blocking layer HBL, and an electron injection layer EIL, but embodiments of the disclosure are not limited thereto.

The hole injection layer HIL may inject holes from the pixel electrode PE to the hole transport layer HTL, and the hole transport layer HTL may transport holes to the light emitting layer EML. The electron injection layer EIL may inject electrons from the common electrode CE to the electron transport layer ETL, and the electron transport layer ETL may transport electrons to the light emitting layer EML.

For example, the common electrode CE may be electrically connected to the base voltage line VSSL. The base voltage VSS, which is one type of the common voltage, may be applied to the common electrode CE through the base voltage line VSSL. The pixel electrode PE may be electrically connected directly or indirectly (through another transistor) to the first node Na of the driving transistor DT of each subpixel SP. In the disclosure, “base voltage VSS” may also be referred to as a first common voltage, a low-potential power voltage, or a low-potential voltage, and “base voltage line VSSL” may also be referred to as a first common voltage line, a low-potential power voltage line, or a low-potential voltage line.

Each light emitting element ED may include portions where the pixel electrode PE, the light emitting layer EML in the intermediate layer LE, and the common electrode CE overlap. A predetermined light emitting area may be formed by each light emitting element ED. For example, the light emitting area of each light emitting element ED may include an overlapping area of the pixel electrode PE, the light emitting layer EML in the intermediate layer EL, and the common electrode CE.

For example, when the light emitting element ED is an organic light emitting diode (OLED), the intermediate layer EL of the light emitting element ED may include an intermediate layer EL including an organic material.

The pixel circuit may control the driving current flowing through the light emitting element ED to drive the light emitting element ED. The pixel circuit may include a driving transistor DT, first to seventh transistors T1 to T7, and a capacitor Cst. Each of the transistors DT, T1 to T7 may include a first electrode, a second electrode, and a gate electrode. One of the first electrode and the second electrode may be a source electrode, and the other of the first electrode and the second electrode may be a drain electrode.

Each of the transistors DT, T1 to T7 may be a P-type thin film transistor or an N-type thin film transistor. In the embodiment of FIG. 4, the first transistor T1 and the seventh transistor T7 are N-type thin film transistors, and the other transistors DT, T2 to T6 are P-type thin film transistors. However, the disclosure is not limited thereto, and according to an embodiment, all or some of the transistors DT, T1 to T7 may be P-type thin film transistors or N-type thin film transistors. Further, the N-type thin film transistor may be an oxide thin film transistor, and the P-type thin film transistor may be a polycrystalline silicon thin film transistor.

Described below is an example in which the first transistor T1 and the seventh transistor T7 are N-type thin film transistors, and the other transistors DT, T2 to T6 are P-type thin film transistors. Accordingly, the first transistor T1 and the seventh transistor T7 are turned on by receiving a high voltage, and the other transistors DT, T2 to T6 are turned on by receiving a low voltage.

According to an embodiment, the first transistor T1 may function as a compensation transistor, the second transistor T2 may function as a data supply transistor, the third and fourth transistors T3 and T4 may function as emission control transistors, the fifth transistor T5 may function as a bias transistor, and the sixth and seventh transistors T6 and T7 may function as initialization transistors.

The light emitting element ED may include an anode electrode (or a pixel electrode) and a cathode electrode. The anode electrode of the light emitting element ED may be connected to the fifth node N5, and the cathode electrode may be connected to the low-potential driving voltage EVSS.

The driving transistor DT may include a first electrode connected to the second node N2, a second electrode connected to the third node N3, and a gate electrode connected to the first node N1. The driving transistor DT may provide the driving current Id to the light emitting element ED based on the voltage of the first node N1 (or the data voltage stored in the capacitor Cst to be described below).

The first transistor T1 may include a first electrode connected to the first node N1, a second electrode connected to the third node N3, and a gate electrode receiving the first scan signal SC1(n). The first transistor T1 may be turned on in response to the first scan signal SC1(n) to be diode-connected between the first node N1 and the third node N3 to sample the threshold voltage Vth of the driving transistor DT. The first transistor T1 may be a compensation transistor.

The capacitor Cst may be connected or formed between the first node N1 and the fourth node N4. The capacitor Cst is connected to the third transistor T1 at the fourth node N4 and is connected to the driving transistor DT at the first node N1. The capacitor Cst may store or maintain the provided high-potential driving voltage ELVDD.

The second transistor T2 may include a first electrode connected to the data line DL (or receiving the data voltage Vdata), a second electrode connected to the driving transistor DT, the third transistor T3, and the fifth transistor T5 at the second node N2, and a gate electrode for receiving the second scan signal SC2(n). The second transistor T2 may be turned on in response to the second scan signal SC2(n) to transfer the data voltage Vdata to the second node N2. The second transistor T2 may be a data supply transistor.

The third transistor T3 and the fourth transistor T4 (or the first and second emission control transistors) may be connected between the high-potential driving voltage ELVDD and the light emitting element ED, forming a current movement path through which the driving current Id generated by the driving transistor DT moves.

The third transistor T3 may include a first electrode connected to a high-potential voltage line VDDL at the fourth node N4 to receive the high-potential driving voltage ELVDD, a second electrode connected to the driving transistor DT, the second transistor T2, and the fifth transistor T4 at the second node N2, and a gate electrode for receiving the emission control signal EM(n).

The fourth transistor T4 may include a first electrode connected to the driving transistor DT and the first transistor T1 at the third node N3, a second electrode connected to the light emitting element ED (e.g., the anode electrode of the light emitting element ED) and the sixth transistor T5 at the fifth node N5, and a gate electrode receiving the emission control signal EM(n).

The third and fourth transistors T3 and T4 may be turned on in response to the emission control signal EM(n) and, in this case, a driving current Id may be provided to the light emitting element ED, and the light emitting element ED may emit light with luminance corresponding to the driving current Id.

The fifth transistor T5 may include a first electrode that is connected to a bias voltage line that supplies a bias voltage Vobs to the first electrode of the fifth transistor T5, a second electrode connected to the driving transistor DT, the third transistor T3, and the second transistor T2 at the second node N2, and a gate electrode receiving a third scan signal SC3(n). The fifth transistor T5 may be a bias transistor.

The sixth transistor T6 may include a first electrode that is connected to a first initialization voltage line that supplies the first initialization voltage Var to the first electrode of the sixth transistor T6, a second electrode connected to the light emitting element ED and the fourth transistor T4 at the fifth node N5, and a gate electrode receiving the third scan signal SC3(n).

The sixth transistor T6 may be turned on in response to the third scan signal SC3(n) before the light emitting element ED emits light (or after the light emitting element ED emits light), and may initialize the anode electrode (or pixel electrode) of the light emitting element ED using the first initialization voltage Var. The light emitting element ED may have a parasitic capacitor formed between the anode electrode and the cathode electrode. While the light emitting element ED emits light, the parasitic capacitor is charged so that the anode electrode of the light emitting element ED may have a specific voltage. Accordingly, the amount of charge accumulated in the light emitting element ED may be initialized by applying the first initialization voltage Var to the anode electrode of the light emitting element ED through the sixth transistor T6.

In the disclosure, the gate electrodes of the fifth and sixth transistors T5 and T6 are configured to commonly receive the third scan signal SC3(n) and are thus turned on or turned off at the same time. However, the disclosure is not necessarily limited thereto, and the gate electrodes of the fifth and sixth transistors T5 and T6 may be configured to receive separate scan signals to be independently controlled.

The seventh transistor T7 may include a first electrode that is connected to a second initialization voltage line that supplies a second initialization voltage Vini to the first electrode of the seventh transistor T7, a second electrode connected to the storage capacitor Cst, the driving transistor DT, and the first transistor T1 at the first node N1, and a gate electrode receiving a fourth scan signal SC4(n).

The seventh transistor T7 may be turned on in response to the fourth scan signal SC4(n) and may initialize the gate electrode of the driving transistor DT using the second initialization voltage Vini. Unnecessary charge may remain in the gate electrode of the driving transistor DT due to the high-potential driving voltage ELVDD stored in the capacitor Cst. Accordingly, the remaining charge amount may be initialized by applying the second initialization voltage Vini to the gate electrode of the driving transistor DT through the seventh transistor T7.

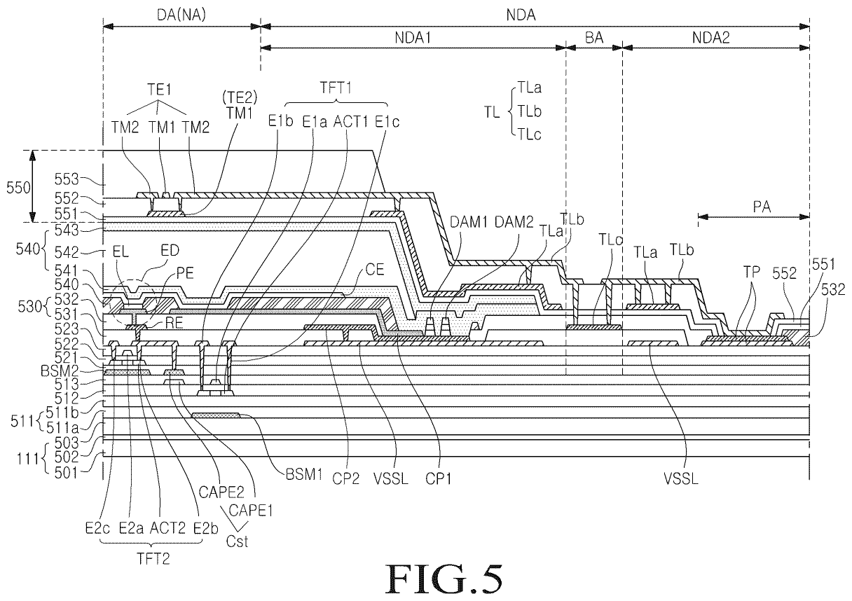

FIG. 5 is a view illustrating a cross-sectional structure taken along dashed line A-A′ of the display panel 110 of FIG. 2 according to embodiments of the disclosure.

Referring to FIG. 5, the display panel 110 according to embodiments of the disclosure may include a substrate 111, a transistor unit, a light emitting element unit, and an encapsulation unit, but embodiments of the disclosure are not limited thereto.

The substrate 111 may be a single layer or multiple layers. When the substrate 111 includes multiple layers, the substrate 111 may include a first substrate 501, an intermediate substrate layer 502, and a second substrate 503. The intermediate substrate layer 502 may be positioned between the first substrate 501 and the second substrate 503.

The transistor unit may include insulation layers 511, 512, 513, 521, 522, and 523 on the substrate 111, thin film transistors TFT1 and TFT2, a storage capacitor Cst, and various electrodes or signal lines.

The thin film transistors TFT1 and TFT2 included in the transistor unit may include a first thin film transistor TFT1 and a second thin film transistor TFT2.

The first thin film transistor TFT1 may include a first active layer ACT1, a first electrode E1a, a second electrode E1b, and a third electrode E1c.

The first electrode E1a may be a gate electrode, the second electrode E1b may be a source electrode or a drain electrode, and the third electrode E1c may be a drain electrode or a source electrode. Hereinafter, for convenience of description, the first electrode E1a is referred to as a first gate electrode E1a, the second electrode E1b is referred to as a first source electrode E1b, and the third electrode E1c is referred to as a first drain electrode E1c, but embodiments of the disclosure are not limited thereto. However, embodiments of the disclosure are not limited thereto.

The first active layer ACT1 may include a first semiconductor material. For example, the first semiconductor material may include an oxide semiconductor, amorphous silicon, polysilicon, or low temperature polysilicon (LTPS), but embodiments of the disclosure are not limited thereto. The first thin film transistor TFT1 may be implemented as a p-channel transistor or an n-channel thin film transistor, but embodiments of the disclosure are not limited thereto.

The second thin film transistor TFT2 may include a second active layer ACT2, a fourth electrode E2a, a fifth electrode E2b, and a sixth electrode E2c.

The fourth electrode E2a may be a gate electrode, the fifth electrode E2b may be a source electrode or a drain electrode, and the sixth electrode E2c may be a drain electrode or a source electrode. Hereinafter, for convenience of description, the fourth electrode E2a is referred to as a second gate electrode E2a, the fifth electrode E2b is referred to as a second source electrode E2b, and the sixth electrode E2c is referred to as a second drain electrode E2c. However, embodiments of the disclosure are not limited thereto.

The second active layer ACT2 may include a second semiconductor material. For example, the second semiconductor material may include an oxide semiconductor, amorphous silicon, polysilicon, or low temperature polysilicon (LTPS), but embodiments of the disclosure are not limited thereto. The second thin film transistor TFT2 may be implemented as a p-channel transistor or an n-channel thin film transistor, but embodiments of the disclosure are not limited thereto.

The purposes of the transistors in the display area DA may be as follows.

For example, all of the transistors in each subpixel SP may be implemented as first thin film transistors TFT1. As another example, all of the transistors in each subpixel SP may be implemented as second thin film transistors TFT2. As another example, some of all of the transistors in each subpixel SP may be implemented as first thin film transistors TFT1, and the others of the transistors may be implemented as second thin film transistors TFT2. In other words, each subpixel SP may include at least one first thin film transistor TFT1 and at least one second thin film transistor TFT2.

When some of all of the transistors in each subpixel SP are implemented as first thin film transistors TFT1 and the others are implemented as second thin film transistors TFT2, the following examples may be possible.

For example, in each subpixel SP, the driving transistor DT may be implemented as a first thin film transistor TFT1, and other transistors (e.g., the scan transistor ST, the emission control transistor, etc.) than the driving transistor DT may be implemented as second thin film transistors TFT2.

As another example, in each subpixel SP, the driving transistor DT may be implemented as a second thin film transistor TFT2, and other transistors (e.g., the scan transistor ST, the emission control transistor, etc.) than the driving transistor DT may be implemented as first thin film transistors TFT1.

In FIG. 5, the second thin film transistor TFT2 connected to the pixel electrode PE of the light emitting element ED may be a driving transistor DT or a transistor different from the driving transistor DT according to the configuration of the subpixel circuit. For example, in FIG. 5, the second thin film transistor TFT2 connected to the pixel electrode PE of the light emitting element ED may be an emission control transistor connected between the driving transistor DT and the light emitting element ED.

The purposes of the transistors in the non-display area NDA may be as follows.

For example, the active layers of the transistors included in the gate-in-panel (GIP) type gate driving circuit may be formed of an oxide semiconductor material. As another example, the active layers of the transistors included in the gate-in-panel (GIP) type gate driving circuit may be formed of a low-temperature polysilicon semiconductor material. As another example, among the transistors included in the gate-in-panel (GIP) type gate driving circuit, some active layers may be formed of a low-temperature polysilicon semiconductor material, and other active layers may be formed of an oxide semiconductor material.

The second active layer ACT2 of the second thin film transistor TFT2 may be positioned higher from (e.g., above) the substrate 111 than the first active layer ACT1 of the first thin film transistor TFT1.

The first buffer layer 511 may be disposed under the first active layer ACT1 of the first thin film transistor TFT1, and a second buffer layer 521 may be disposed under the second active layer ACT2 of the second thin film transistor TFT2. For example, the first active layer ACT1 of the first thin film transistor TFT1 may be positioned on the first buffer layer 511, and the second active layer ACT2 of the second thin film transistor TFT2 may be positioned on the second buffer layer 521. The second buffer layer 521 may be positioned higher than the first buffer layer 511.

The storage capacitor Cst may be disposed in various metal layers within the display panel 110. For example, the storage capacitor Cst may include a first capacitor electrode CAPE1 and a second capacitor electrode CAPE2.

The light emitting element portion may include a plurality of light emitting elements ED disposed on the planarization layer 530. Each of the light emitting elements ED may include a pixel electrode PE, an intermediate layer EL, and a common electrode CE.

The encapsulation unit may include an encapsulation layer 540 on the plurality of light emitting elements ED. The encapsulation layer 540 may be a single layer or multiple layers, but embodiments of the disclosure are not limited thereto. In addition to the encapsulation layer 540, the encapsulation unit may further include at least one dam DAM for preventing or at least reducing a material constituting the encapsulation layer 540 from overflowing. In particular, when the second encapsulation layer 542 included in the encapsulation layer 540 is an organic encapsulation layer formed of an organic material, the dam DAM may prevent or at least reduce the organic material from overflowing.

Hereinafter, a structure or a vertical structure of the display panel 110 according to embodiments of the disclosure is described in more detail with reference to FIG. 5.

Referring to FIG. 5, the first buffer layer 511 may be disposed on the substrate 111. The first buffer layer 511 may be a single layer or multiple layers, but embodiments of the disclosure are not limited thereto. When the first buffer layer 511 includes multiple layers, the first buffer layer 511 may include a lower buffer layer 511a and an upper buffer layer 511b.

The first active layer ACT1 of the first thin film transistor TFT1 may be disposed on the first buffer layer 511. The first active layer ACT1 may include a channel area in which a channel is formed, a source connection area on one side of the channel area, and a drain connection area on the other side of the channel area.

The first gate insulation layer 512 may be disposed on the first active layer ACT1 of the first thin film transistor TFT1. The first gate electrode E1a of the first thin film transistor TFT1 may be disposed on the first gate insulation layer 512. The first inter-layer insulation layer 513 may be disposed on the first gate electrode E1a of the first thin film transistor TFT1. Here, the metal layer where the first gate electrode E1a of the first thin film transistor TFT1 is disposed may be referred to as a gate metal layer.

The second buffer layer 521 may be disposed on the first inter-layer insulation layer 513.

The second active layer ACT2 of the second thin film transistor TFT2 may be disposed on the second buffer layer 521. The second active layer ACT2 may include a channel area in which a channel is formed, a source connection area on one side of the channel area, and a drain connection area on the other side of the channel area.

The second gate insulation layer 522 may be disposed on the second active layer ACT2 of the second thin film transistor TFT2. The second gate electrode E2a of the second thin film transistor TFT2 may be disposed. The second inter-layer insulation layer 523 may be disposed on the second gate electrode E2a of the second thin film transistor TFT2. Here, the second gate electrode E2a of the second thin film transistor TFT2 may be referred to as a second gate metal layer.

The first source electrode E1b and the first drain electrode E1c of the first thin film transistor TFT1, and the second source electrode E2b and the second drain electrode E2c of the second thin film transistor TFT2 may be disposed on the second interlayer insulation layer 523.

The first source electrode E1b and the first drain electrode E1c of the first thin film transistor TFT1 may be connected to the source connection area and the drain connection area, respectively, of the first active layer ACT1 through holes of the second inter-layer insulation layer 523, the second gate insulation layer 522, the second buffer layer 521, the first inter-layer insulation layer 513, and the first gate insulation layer 512.

The second source electrode E2b and the second drain electrode E2c of the second thin film transistor TFT2 may be connected to the source connection area and the drain connection area, respectively, of the second active layer ACT2 through the holes of the second inter-layer insulation layer 523 and the second gate insulation layer 522.

The first source electrode E1b and the first drain electrode E1c of the first thin film transistor TFT1, and the second source electrode E2b and the second drain electrode E2c of the second thin film transistor TFT2 may include a first source-drain metal and may be disposed in the first source-drain metal layer.

Referring to FIG. 5, e.g., the storage capacitor Cst may be formed by a first capacitor electrode CAPE1 and a second capacitor electrode CAPE2. In some cases, the storage capacitor Cst may be formed by three or more capacitor electrodes, or may have a form in which two or more capacitors are connected in parallel.

Each of the first capacitor electrode CAPE1 and the second capacitor electrode CAPE2 may be disposed on various metal layers disposed in the display panel 110.

For example, the first capacitor electrode CAPE1 may include the same first gate metal as the first gate electrode E1a of the first thin film transistor TFT1 on the first gate insulation layer 512 and may be disposed in the first gate metal layer, but embodiments of the disclosure are not limited thereto. For example, the second capacitor electrode CAPE2 may be disposed on the first inter-layer insulation layer 513.

The second source electrode E2b of the second thin film transistor TFT2 may be electrically connected to the second capacitor electrode CAPE2 through holes of the second inter-layer insulation layer 323, the second gate insulation layer 522, and the second buffer layer 521.

For example, when the subpixel SP is configured as shown in FIG. 5, the first thin film transistor TFT1 may be the scanning transistor ST of FIG. 5, and the second thin film transistor TFT2 may be the driving transistor DT of FIG. 5.

Referring to FIG. 5, the transistor unit may further include a first shield pattern BSM1 disposed on the substrate 111. The first shield pattern BSM1 may overlap the first active layer ACT1 of the first thin film transistor TFT1. The first shield pattern BSM1 may be disposed under the first active layer ACT1 of the first thin film transistor TFT1. For example, the first shield pattern BSM1 may be disposed between the substrate 111 and the first buffer layer 511, or may be disposed between the lower buffer layer 511a and the upper buffer layer 511b.

The transistor unit may further include a second shield pattern BSM2 disposed on the substrate 111. The second shield pattern BSM2 may overlap the second active layer ACT2 of the second thin film transistor TFT2. The second shield pattern BSM2 may be disposed under the second active layer ACT2 of the second thin film transistor TFT2. For example, the second shield pattern BSM2 may be disposed in a metal layer between the first insulation layer 513 and the second buffer layer 521. The second shield pattern BSM2 may be disposed in the same metal layer as the second capacitor CAPE2, but embodiments of the disclosure are not limited thereto. As another example, the second shield pattern BSM2 may be disposed in the same first gate metal layer as the first gate electrode E1a of the first thin film transistor TFT1.

The planarization layer 530 may be disposed on the first thin film transistor TFT1 and the second thin film transistor TFT2, and may be disposed under the light emitting element ED. The planarization layer 530 may be an organic insulation layer including an organic insulating material.

For example, the planarization layer 530 may include a single layer. As another example, the planarization layer 530 may include multiple (e.g., two) layers. The planarization layer 530 may include a first planarization layer 531 and a second planarization layer 532. As another example, the planarization layer 530 may include three or more layers. Embodiments of the disclosure are not limited thereto.

Referring to FIG. 5, the first planarization layer 531 may be disposed on the first source electrode E1b and the first drain electrode E1c of the first thin film transistor TFT1, and the second source electrode E2b and the second drain electrode E2c of the second thin film transistor TFT2. For example, the first planarization layer 531 may be disposed on the first thin film transistor TFT1 and the second thin film transistor TFT2. For example, the first planarization layer 531 may be disposed while covering both the first thin film transistor TFT1 and the second thin film transistor TFT2.

Referring to FIG. 5, a connection electrode RE may be disposed on the first planarization layer 531. The connection electrode RE may electrically connect the second source electrode E2b of the second thin film transistor TFT2 and the pixel electrode PE.

The connection electrode RE may be electrically connected to the second source electrode E2b of the second thin film transistor TFT2 through the hole of the first planarization layer 531. The second source electrode E2b of the second thin film transistor TFT2 may be electrically connected to the second capacitor electrode CAPE2 of the storage capacitor Cst.

The connection electrode RE may be disposed in the second source-drain metal layer on the first planarization layer 531 and may include a second source-drain metal.

The second planarization layer 532 may be disposed on the connection electrode RE.

Referring to FIG. 5, the light emitting element ED may be formed on the second planarization layer 532. The light emitting element ED may include a pixel electrode PE, an intermediate layer EL, and a common electrode CE. The emission area of the light emitting element ED may be formed in an area in which the pixel electrode PE, the intermediate layer EL, and the common electrode CE overlap and contact each other.

The pixel electrode PE may be disposed on the second planarization layer 532. The pixel electrode PE may be electrically connected to the connection electrode RE through the hole of the second planarization layer 532.

A bank 540 may be disposed on the pixel electrode PE. The opening of the bank 540 may expose a portion of the pixel electrode PE to form the emission area. The opening of the bank 540 may overlap a portion of the pixel electrode PE.

The intermediate layer EL of the light emitting element ED may be disposed on a portion of the pixel electrode PE and the bank 540. The common electrode CE may be disposed on the intermediate layer EL.

Referring to FIG. 5, the encapsulation unit may be disposed on the light emitting element unit and may be positioned on the common electrode CE. The encapsulation unit may include the encapsulation layer 540 formed on the common electrode CE.

The encapsulation layer 540 may prevent moisture or oxygen from penetrating into the organic material included in the intermediate layer EL of the light emitting element ED. The encapsulation layer 540 may be composed of a single layer or a plurality of layers.

For example, the first encapsulation layer 541 and the third encapsulation layer 543 may include an inorganic layer, and the second encapsulation layer 542 may include an organic layer, but embodiments of the disclosure are not limited thereto.

The display panel 110 according to embodiments of the disclosure may have a built-in touch sensor. In this case, the display panel 110 according to embodiments of the disclosure may include a touch sensor layer 550 disposed on the encapsulation layer 540 and having a touch sensor.

Referring to FIG. 5, the touch sensor layer 550 may include a plurality of touch electrodes TE corresponding to touch sensors, and may include at least one touch metal layer for forming the plurality of touch electrodes TE.

For example, the touch sensor layer 550 may include a first touch metal layer on which a plurality of first touch metals TM1 are disposed, and a second touch metal layer on which a plurality of second touch metals TM2 are disposed, to form the plurality of touch electrodes TE. In this case, the touch sensor layer 550 may further include a touch interlayer insulation layer 552 disposed between the first touch metal layer and the second touch metal layer.

For example, one of the first touch metal layer and the second touch metal layer may be a sensor metal layer and the other may be a bridge metal layer.

For example, the first touch metal layer may be a bridge metal layer, and the second touch metal layer may be a sensor metal layer. In this case, the plurality of second touch metals TM2 disposed in the second touch metal layer may be sensor metals forming touch sensors, and the plurality of first touch metals TM1 disposed in the first touch metal layer may be bridge metals electrically connecting the plurality of second touch metals TM2, which are sensor metals. For example, two or more second touch metals TM2 and at least one first touch metal TM1 may constitute one first touch electrode TE1. In this case, two or more second touch metals TE2 may be electrically connected by at least one first touch metal TM1.

Referring to FIG. 5, the touch sensor layer 550 may further include a touch buffer layer 551 disposed on the encapsulation layer 540. The touch buffer layer 551 may be disposed between the encapsulation layer 540 and the touch metal layer. For example, the first touch metal layer may be disposed on the touch buffer layer 551, and the touch interlayer insulation layer 552 may be disposed on the first touch metal layer.

Referring to FIG. 5, the touch sensor layer 550 may further include a touch protection layer 553 disposed to cover the touch metal layer. For example, the touch protection layer 553 may be disposed on the second touch metal layer.

For example, the touch buffer layer 551 may be an inorganic layer including an inorganic insulating material or an organic layer including an organic insulating material, the touch interlayer insulation layer 552 may be an inorganic layer including an inorganic insulating material or an organic layer including an organic insulating material, and the touch protection layer 553 may be an inorganic layer including an inorganic insulating material or an organic layer including an organic insulating material.

For example, at least one of the touch buffer layer 551 and the touch interlayer insulation layer 552 may extend from the display area DA to the non-display area NDA. The touch protection layer 553 may be disposed to extend from the display area DA to the non-display area NDA.

The touch routing line TL may electrically connect the touch electrode TE and the touch pad TP. The touch routing line TL may be formed of at least one of the first touch metal TM1 and the second touch metal TM2.

When one touch routing line TL is formed of the first touch metal TM1 and the second touch metal TM2, the first touch metal TM1 and the second touch metal TM2 constituting one touch routing line TL may be electrically connected through a hole in the insulation layer 352.

The touch routing line TL may be disposed along the inclined surface of the encapsulation layer 540, and may extend to the touch pad TP through the upper portion of the dam DAM1 and DAM2.

The touch buffer layer 551 may have an opening exposing at least a portion of the touch pad TP. The touch routing line TL may be electrically connected to the touch pad TP through the opening of the touch buffer layer 551. The touch interlayer insulation layer 552 may be disposed on the touch routing line TL, and may extend to an area where the touch pad TP is disposed. The touch protection layer 553 may be disposed only in the display area DA, or may extend to the non-display area NDA to be disposed on the touch routing line TL. In some cases, the touch protection layer 553 may further extend to the upper portion of the touch pad TP.

Each of the plurality of touch electrodes TE may be a mesh-type electrode having a plurality of openings. In this case, each of the plurality of touch electrodes TE may be formed of at least one second touch metal TM2. However, embodiments of the disclosure are not limited thereto.

For example, the plurality of touch electrodes TE may include a first touch electrode TE1 and a second touch electrode TE2. When the first touch metal layer is a bridge metal layer and the second touch metal layer is a sensor metal layer, two or more second touch metals TM2 forming the first touch electrode TE1 corresponding to the touch sensor may be electrically connected through at least one first touch metal TM1, which are bridge metals. For example, the two second touch metals TM2 spaced apart from each other may be electrically connected by the first touch metal TM1 to constitute one first touch electrode TE1.

Referring to FIG. 5, the plurality of first touch metals TM1 and the plurality of second touch metals TM2 may be disposed not to overlap the light emitting element ED. The plurality of first touch metals TM1 and the plurality of second touch metals TM2 may overlap the bank 540. Accordingly, the luminous efficiency of the light emitting element ED may increase.

Referring to FIG. 5, the touch routing line TL may connect the touch pad TP disposed in the pad area PA in the second non-display area NDA2 and the first touch electrode TE1 disposed in the display area DA. To that end, the touch routing line TL may be disposed across the second non-display area NDA2, the bending area BA, and the first non-display area NDA1.

The touch routing line TL may include a first line section TLa, a second line section TLb, and a third line section TLc. For example, the touch routing line TL may include the first line section TLa and the second line section TLb disposed in the first non-display area NDA1 and the second non-display area NDA2, and the third line section TLc disposed in the bending area BA. The third line section TLc may connect the first line section TLa and the second line section TLb.

The first line section TLa of the touch routing line TL is a single line section, and may further include a third touch metal layer where the third touch metal TM3 is disposed.

The first line section TLa of the touch routing line TL may extend along the inclined surface of the encapsulation layer 540 and may extend via the upper portion of at least one dam DAM1 or DAM2.

Referring to FIG. 5, the display panel 100 according to embodiments of the disclosure may further include a common voltage line VSSL to which the common voltage VSS is applied and a connection pattern CP connecting the common electrode CE and the common voltage line VSSL. For example, the connection pattern CP may include the same material as that of the pixel electrode PE. For example, the connection pattern CP may include a first connection pattern CP1 and a second connection pattern CP2. For example, the first connection pattern CP1 may connect the common electrode CE and the second connection pattern CP2, and the second connection pattern CP2 may connect the first connection pattern CP1 and the common voltage line VSSL, but embodiments of the disclosure are not limited thereto.

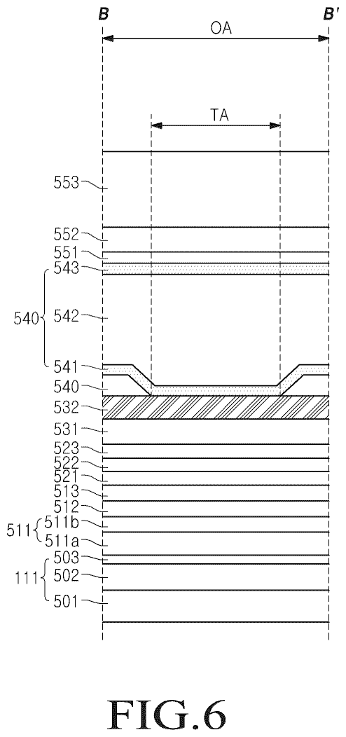

FIG. 6 is a cross-sectional view taken along dashed line B-B′ of the optical area of FIG. 1 according to one embodiment.

A stacked structure for the optical area OA is described with reference to FIG. 6.

The optical area OA may include both the emission area EA and the transmissive area TA. Further, the emission area EA included in the optical area OA may have the same stacked structure as the stacked structure of the normal area NA illustrated in FIG. 5. Therefore, the stacked structure of the transmissive area TA in the optical area OA is described below in detail.

The cathode electrode CE may not be disposed in the transmissive area TA. In other words, the transmissive area TA in the optical area OA may correspond to the opening of the cathode electrode CE.

Further, the shield layers BSM1 and BSM2 may not be disposed in the transmissive area TA. In other words, the transmissive area TA in the optical area OA may not overlap the first shield pattern BSM1 and the second shield pattern BSM2.

The substrate 111 and various insulation layers 511, 512, 513, 521, 522, and 523 disposed in the emission area EA included in the normal area NA and the optical area OA may be equally disposed in the transmissive area TA in the optical area OA.

However, in the emission area EA included in the normal area NA and the optical area OA, a material layer (e.g., a metal material layer, a semiconductor layer, etc.) having electrical properties other than the insulating material may not be disposed in the transmissive area TA in the optical area OA.

For example, referring to FIG. 6, the metal material layers E1a, E1b, E1c, E2a, E2b, E2c, CAPE1, and CAPE2 related to the transistor and the semiconductor layers ACT1 and ACT2 may not be disposed in the transmissive area TA in the optical area OA to increase the light transmittance of the optical area OA.

Further, referring to FIG. 6, the anode electrode PE and the cathode electrode CE included in the light emitting element ED may not be disposed in the transmissive area TA in the optical area OA. However, the emission layer EML may or may not be disposed in the transmissive area TA in the optical area OA.

Thus, light transmittance of the transmissive area TA in the optical area OA may be provided. Therefore, the second optical electronic device may receive light transmitted through the transmissive area TA and perform the corresponding function (e.g., sensing the approach of an object or human body, detecting external illuminance, etc.).

Meanwhile, the thin film transistors TFT1 and TFT2, the storage capacitor Cst, and the light emitting elements ED may not be disposed in the transmissive area TA of the optical area OA.

Therefore, the output of the data signal corresponding to the video image at the corresponding position of the transmissive area TA may not be necessary in the transmissive area TA. If the data signal corresponding to the video image corresponding to the position of the transmissive area TA is output as it is, it is not output to the display panel 110 because there is no configuration of the subpixel SP, and a data transition may occur due to the output of an unnecessary data signal. As the number of data transitions increases, the power consumption of the display device 100 may increase.

In an embodiment of the disclosure, a module or circuit for preventing a data transition from occurring due to the output of an unnecessary signal in the transmissive area TA of the optical area OA is provided, thereby addressing the increase in power consumption as described above.

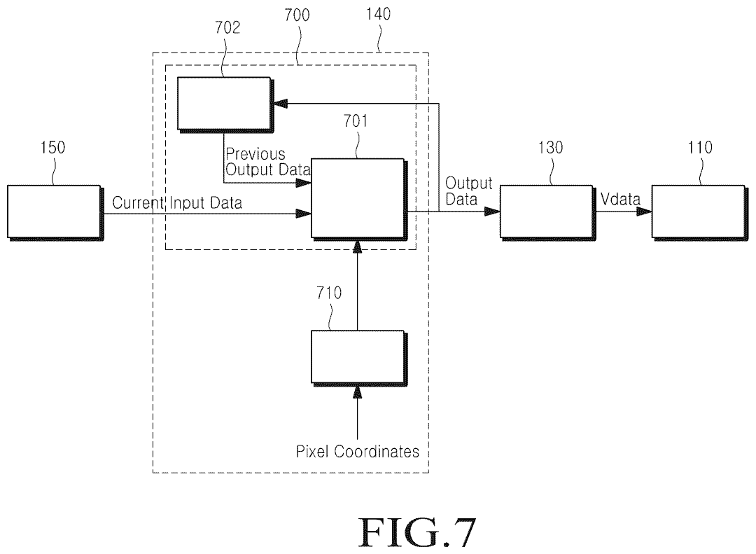

FIG. 7 is a view illustrating a configuration of a transition reducer circuit 700 to prevent an unnecessary data transition in a transmissive area TA disposed on a display panel 110.

The transition reducer circuit 700 may be a component included in the display controller 140. The transition reducer circuit 700 may include a data output unit 701 (e.g., a data output circuit) and a data buffer unit 702 (e.g., a data buffer circuit). The data output unit 701 may receive current input image data from the host system 150. Hereinafter, the current input image data may be abbreviated as the current input data. Further, the current input data may mean the same signal as the input image data Input Data input from the host system 150 to the display controller 140 described above in FIG. 1.

Further, the data output unit 701 may receive the previous output data from the data buffer unit 702.

The control signal output unit 710 (e.g., a control signal output circuit) may store matrix coordinates corresponding to the emission area EA and the transmissive area TA of the display panel 110 in advance. For example, in the step of manufacturing the display device 100, the matrix coordinates of the emission area EA and the transmissive area TA defined in advance may be stored in the memory included in the control signal output unit 710.

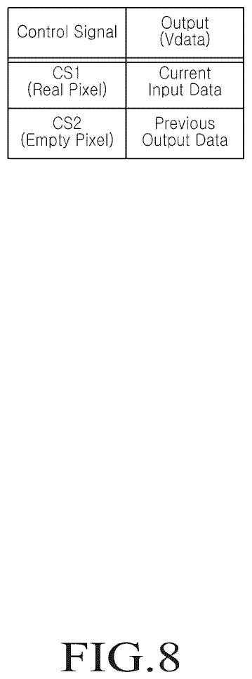

FIG. 8 is a table representing output data according to control signals output from a control signal output unit 710 according to one embodiment.

Referring to FIGS. 7 and 8, when the matrix coordinates of the display panel 110 to which the data voltage Vdata is to be applied correspond to the emission area EA where the subpixel SP is disposed, the control signal output unit 710 may supply a first control signal CS1 to the data output unit 701. Alternatively, the control signal output unit 710 may supply the second control signal CS2 that is different from the first control signal CS1 to the data output unit 701 when the matrix coordinates of the display panel 110 to which the data voltage Vdata is to be applied correspond to the transmissive area TA where the subpixel SP is not disposed.

Referring to FIGS. 7 and 8, when the first control signal CS1 is supplied from the control signal output unit 710, the data output unit 701 may output the current input data received from the host system 150 as output data. Alternatively, when the second control signal CS2 is supplied from the control signal output unit 710, the data output unit 701 may output the previous output data supplied from the data buffer unit 702 as output data.

In other words, when the matrix coordinates of the display panel 110 to which the data voltage Vdata is to be input are the emission area EA, current input data from the transition reducer circuit 700 may be supplied as output data to the data driving circuit 130. Alternatively, when the matrix coordinates of the display panel 110 to which the data voltage Vdata is to be input are the transmissive area TA, the previous output data may be supplied from the transition reducer circuit 700 to the data driving circuit 130 as output data.

The output data output from the data output unit 701 may be supplied to the data driving circuit 130 and may be supplied to the data buffer unit 702. The data buffer unit 702 may update and store the output data supplied from the data output unit 701 as previous output data.

In other words, the data output unit 701 may receive current input data from the host system 150 and previous output data from the data buffer unit 702. In this case, when the first control signal CS1 is supplied from the control signal output unit 710, the current input data may be supplied to the data buffer unit 702 again to be updated and stored as previous output data. Alternatively, when the second control signal CS2 is supplied from the control signal output unit 710, the previous output data may be supplied again to the data buffer unit 702, and the data buffer unit 702 may store the previously stored previous output data as it is.

The output data output from the data output unit 701 to the data driving circuit 130 may be output as a data voltage Vdata in the form of analog voltage data for driving the display panel 110 through the data driving circuit 130.

Meanwhile, a plurality of subpixels SP and a plurality of transmissive areas TA may be disposed in each of the first data line, the second data line, the third data line, and the fourth data line described above with reference to FIG. 1. For example, a first subpixel SP may be disposed in the first row OH1 of the first data line. A transmissive area TA may be disposed in the second row OH2 of the first data line. A third subpixel SP may be disposed in the third row OH3 of the first data line. A transmissive area TA may be disposed in the fourth row OH4 of the first data line. As such, the subpixel SP and the transmissive area TA may be alternately disposed in one data line DL. However, the pattern where the subpixel SP and the transmissive area TA are disposed in the data line DL of the optical area OA may be variously modified and is not limited to the previous example.

As an example of driving the data driving circuit 130, the data driving circuit 130 may supply the first data voltage to the first data line of the display panel 110 at the first driving timing. The data driving circuit 130 may supply the second data voltage to the first data line of the display panel 110 at the second driving timing. The data driving circuit 130 may supply the third data voltage to the first data line of the display panel 110 at the third driving timing. The data driving circuit 130 may supply the fourth data voltage to the first data line of the display panel 110 at the fourth driving timing.

In this case, at the first driving timing, the control signal output unit 710 may supply the first control signal CS1 to the data output unit 701 when the matrix coordinates of the display panel 110 to which the data voltage Vdata is input correspond to the emission area EA where the subpixel SP is disposed at the current timing.

The data output unit 701 receiving the first control signal CS1 at the first driving timing may supply the data driving circuit 130 with the first input signal which is the current input data, as the output data, out of the first input signal which is the current input data received from the host system 150 and the zeroth input signal which is the previous output data received from the data buffer unit 702. In this case, the zeroth input signal may be a signal output from the data output unit 701 at the zeroth driving timing prior to the first driving timing.

Further, the first input signal may be a signal that controls the data driving circuit 130 to output the first data voltage through the data output unit 701. Likewise, the zeroth input signal may be a signal that controls the data driving circuit 130 to output the zeroth data voltage through the data output unit 701.

Further, output data corresponding to the first input signal output from the data output unit 701 may be supplied to the data buffer unit 702 and updated and stored as previous output data in the data buffer unit 702.

The data driving circuit 130 receiving the output data corresponding to the first input signal at the first driving timing may supply the first data voltage to the first data line of the display panel 110. The first data voltage output from the data driving circuit 130 may be supplied to the subpixels SP in the area corresponding to the first column OV1 and the first row OH1 of the optical area OA connected to the first data line.

At the second driving timing after the first driving timing, the control signal output unit 710 may supply the second control signal CS2 to the data output unit 701 when the matrix coordinates of the display panel 110 to which the data voltage Vdata is input correspond to the transmissive area TA at the current timing.

The data output unit 701 receiving the second control signal CS2 at the second driving timing may supply the data driving circuit 130 with the first input signal which is the previous output data, as the output data, out of the second input signal which is the current input data received from the host system 150 and the first input signal which is the previous output data received from the data buffer unit 702.

In this case, the second input signal may be a signal that controls the data driving circuit 130 to output the second data voltage through the data output unit 701.

Further, output data corresponding to the first input signal output from the data output unit 701 may be supplied to the data buffer unit 702 and updated and stored as previous output data in the data buffer unit 702.

The data driving circuit 130 receiving the output data corresponding to the first input signal at the second driving timing may supply the second data voltage to the first data line of the display panel 110. In this case, the second data voltage may be the same signal as the first data voltage. The second data voltage output from the data driving circuit 130 may not be supplied to the subpixel SP in the first column OV1 of the optical area OA connected to the first data line since a subpixel is not present in the first column OV1 and second row OH2.

At the third driving timing after the second driving timing, the control signal output unit 710 may supply the first control signal CS1 to the data output unit 701 when the matrix coordinates of the display panel 110 to which the data voltage Vdata is input correspond to the emission area EA where the subpixel SP is disposed at the current timing.

The data output unit 701 receiving the first control signal CS1 at the third driving timing may supply the data driving circuit 130 with the third input signal which is the current input data, as the output data, out of the third input signal which is the current input data received from the host system 150 and the first input signal which is the previous output data received from the data buffer unit 702.

In this case, the third input signal may be a signal that controls the data driving circuit 130 to output the third data voltage through the data output unit 701.

Further, output data corresponding to the third input signal output from the data output unit 701 may be supplied to the data buffer unit 702 and updated and stored as previous output data in the data buffer unit 702.

The data driving circuit 130 receiving the output data corresponding to the third input signal at the third driving timing may supply the third data voltage to the first data line of the display panel 110. The third data voltage output from the data driving circuit 130 may be supplied to the subpixels SP in the area corresponding to the first column OV1 and the third row OH3 of the optical area OA connected to the first data line.

At the fourth driving timing after the third driving timing, the control signal output unit 710 may supply the second control signal CS2 to the data output unit 701 when the matrix coordinates of the display panel 110 to which the data voltage Vdata is input correspond to the transmissive area TA at the current timing.

The data output unit 701 receiving the second control signal CS2 at the fourth driving timing may supply the data driving circuit 130 with the third input signal which is the previous output data, as the output data, out of the fourth input signal which is the current input data received from the host system 150 and the third input signal which is the previous output data received from the data buffer unit 702.

In this case, the fourth input signal may be a signal that controls the data driving circuit 130 to output the fourth data voltage through the data output unit 701.

Further, output data corresponding to the third input signal output from the data output unit 701 may be supplied to the data buffer unit 702 and updated and stored as previous output data in the data buffer unit 702.

The data driving circuit 130 receiving the output data corresponding to the third input signal at the fourth driving timing may supply the fourth data voltage to the first data line of the display panel 110. In this case, the fourth data voltage may be the same signal as the third data voltage. The fourth data voltage output from the data driving circuit 130 may not be supplied to the subpixel SP in the first column OV1 and fourth row OH4 of the optical area OA connected to the first data line since a subpixel is not disposed in the first column OV1 and fourth row OH4.

In other words, at the second driving timing which is the driving timing corresponding to the transmissive area TA disposed in the second row OH2 of the first column OV1 of the optical area OA, the input data of the host system 150 which is the data corresponding to the second row OH2 of the first column OV1 of the optical area OA may be changed into the output data corresponding to the first row OH1 of the first column OV1 of the optical area OA which was output at the first driving timing and may be supplied to the data driving circuit 130.

According to the driving of the transition reducer circuit 700 described above, since a data transition of the driving timing corresponding to the transmissive area TA of the optical area OA is not generated, power consumption of the display device 100 is decreased.

To describe this, when the subpixel SP disposed in the normal area NA and the subpixel SP disposed in the optical area OA are driven, the data voltage values of input data of the display controller 140 and output data of the data driving circuit 130 corresponding thereto may be compared.

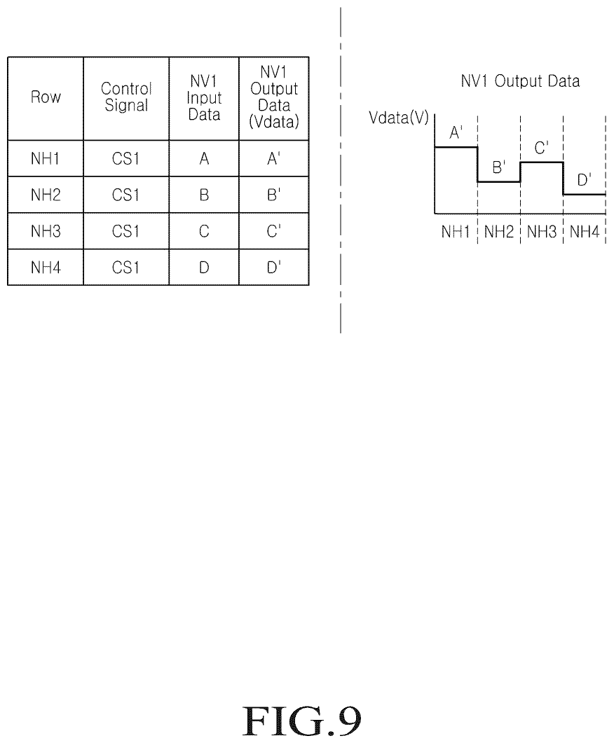

FIG. 9 illustrates a table and a graph of input data and output data corresponding to each row in area A which is a portion of the normal area NA of FIG. 1.

Referring to the table illustrated in FIG. 9, a first data line may be disposed in a first column NV1 of the normal area NA to be connected to each subpixel SP disposed in the first column NV1. A subpixel SP may be disposed in each of the first row NH1, the second row NH2, the third row NH3, and the fourth row NH4 of the first column NV1 of the normal area NA, and an emission area EA corresponding to the subpixel SP may be disposed.

At the first driving timing, the data output unit 701 may receive current input data corresponding to the A value shown in the table of FIG. 9 from the host system 150. Further, the data output unit 701 may receive the previous output data, which is the value output from the data output unit 701 at the driving timing before the first driving timing, from the data buffer unit 702.

At the first driving timing when the subpixels SP disposed in the first column NV1 and the first row NH1 of the normal area NA are driven, the control signal output unit 710 may supply the first control signal CS1 to the data output unit 701 through pre-stored data.

When receiving the first control signal CS1 from the control signal output unit 710 at the first driving timing, the data output unit 701 may output current input data corresponding to the A value supplied from the host system 150 to the data driving circuit 130.

The data driving circuit 130 may supply the A′ value, which is an analog data voltage corresponding to the A value, to the subpixel SP disposed in the first column NV1 and first row NH1 through the first data line.

At the second driving timing after the first driving timing, the data output unit 701 may receive current input data corresponding to the B value shown in the table of FIG. 9 from the host system 150. Further, the data output unit 701 may receive the previous output data, which corresponds to the A value output from the data output unit 701 at the first driving timing before the second driving timing, from the data buffer unit 702.

At the second driving timing when the subpixels SP disposed in the first column NV1 and the second row NH2 of the normal area NA are driven, the control signal output unit 710 may supply the first control signal CS1 to the data output unit 701 through pre-stored data.

When receiving the first control signal CS1 from the control signal output unit 710 at the second driving timing, the data output unit 701 may output current input data corresponding to the B value supplied from the host system 150 to the data driving circuit 130.

The data driving circuit 130 may supply the B′ value, which is an analog data voltage corresponding to the B value, to the subpixel SP disposed in the first column NV1 and second row NH2 through the first data line.

At the third driving timing after the second driving timing, the data output unit 701 may receive current input data corresponding to the C value shown in the table of FIG. 9 from the host system 150. Further, the data output unit 701 may receive the previous output data, which corresponds to the B value output from the data output unit 701 at the second driving timing before the third driving timing, from the data buffer unit 702.

At the third driving timing when the subpixels SP disposed in the first column NV1 and the third row NH3 of the normal area NA are driven, the control signal output unit 710 may supply the first control signal CS1 to the data output unit 701 through pre-stored data.

When receiving the first control signal CS1 from the control signal output unit 710 at the third driving timing, the data output unit 701 may output current input data corresponding to the C value supplied from the host system 150 to the data driving circuit 130.

The data driving circuit 130 may supply the C′ value, which is an analog data voltage corresponding to the C value, to the subpixel SP disposed in the first column NV1 and third row NH3 through the first data line.

At the fourth driving timing after the third driving timing, the data output unit 701 may receive current input data corresponding to the D value shown in the table of FIG. 9 from the host system 150. Further, the data output unit 701 may receive the previous output data, which corresponds to the C value output from the data output unit 701 at the third driving timing before the fourth driving timing, from the data buffer unit 702.

At the fourth driving timing when the subpixels SP disposed in the first column NV1 and the fourth row NH4 of the normal area NA are driven, the control signal output unit 710 may supply the first control signal CS1 to the data output unit 701 through pre-stored data.

When receiving the first control signal CS1 from the control signal output unit 710 at the fourth driving timing, the data output unit 701 may output current input data corresponding to the D value supplied from the host system 150 to the data driving circuit 130.

The data driving circuit 130 may supply the D′ value, which is an analog data voltage corresponding to the D value, to the subpixel SP disposed in the first column NV1 and fourth row NH4 through the first data line.

In this case, a data transition may occur through a change in signal from the display controller 140 to the data driving circuit 130 and from the data driving circuit 130 to the display panel 110 so as to output the A′ value, the B′ value, the C′ value, and the D′ value to the subpixels in rows NH1, NH2, NH3, and NH4 of the first column NV1.

In the case of the optical area OA where the transmissive area TA is disposed rather than the normal area NA, since data transition is unnecessary at the driving timing corresponding to the transmissive area TA, the transition reducer circuit 700 may output the previous output signal as it is at the driving timing corresponding to the transmissive area TA.

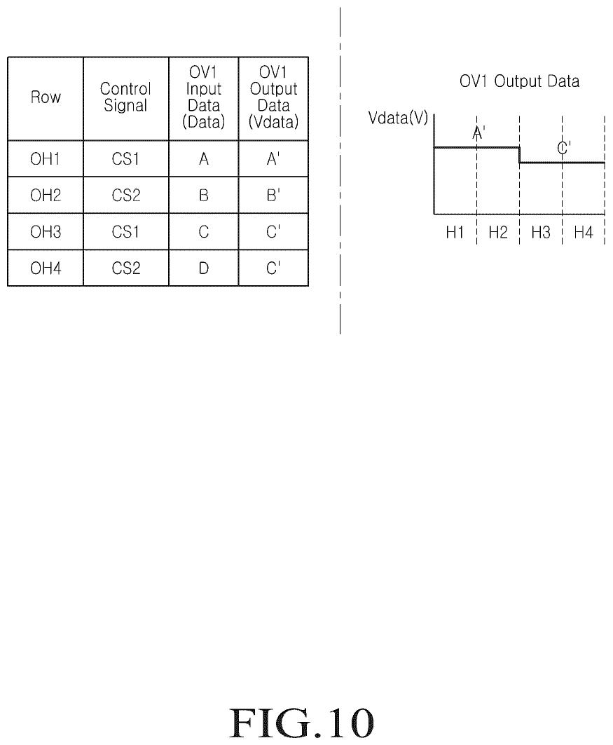

FIG. 10 illustrates a table and a graph of input data and output data corresponding to each row in area B which is a portion of the optical area OA of FIG. 1 according to one embodiment.

Referring to the table illustrated in FIG. 10, a first data line may be disposed in a first column OV1 of the optical area OA to be connected to each subpixel SP disposed in the first column OV1. A subpixel SP may be disposed in each of the first row OH1 and the third row OH3 of the first column OV1 of the optical area OA, and an emission area EA corresponding to the subpixel SP may be disposed. A transmissive area TA may be disposed in each of the second row OH2 and the fourth row OH4 of the first column OV1 of the optical area OA.

At the first driving timing, the data output unit 701 may receive current input data corresponding to the A value shown in the table of FIG. 10 from the host system 150. Further, the data output unit 701 may receive the previous output data, which is the value output from the data output unit 701 at the driving timing before the first driving timing, from the data buffer unit 702.

At the first driving timing when the subpixels SP disposed in the first column OV1 and the first row OH1 of the optical area OA are driven, the control signal output unit 710 may supply the first control signal CS1 to the data output unit 701 through pre-stored data.

When receiving the first control signal CS1 from the control signal output unit 710 at the first driving timing, the data output unit 701 may output current input data corresponding to the A value supplied from the host system 150 to the data driving circuit 130.

The data driving circuit 130 may supply the A′ value, which is an analog data voltage corresponding to the A value, to the subpixel SP disposed in the first column OV1 and first row OH1 through the first data line.

At the second driving timing after the first driving timing, the data output unit 701 may receive current input data corresponding to the B value shown in the table of FIG. 10 from the host system 150. Further, the data output unit 701 may receive the previous output data, which corresponds to the A value output from the data output unit 701 at the first driving timing before the second driving timing, from the data buffer unit 702.

At the second driving timing when the subpixels SP disposed in the first column OV1 and the second row OH2 of the optical area OA are driven, the control signal output unit 710 may supply the second control signal CS2 to the data output unit 701 through pre-stored data.

When receiving the second control signal CS2 from the control signal output unit 710 at the second driving timing, the data output unit 701 may output the previous output data corresponding to the A value received from the data buffer unit 702 to the data driving circuit 130.

The data driving circuit 130 may supply the A′ value which is an analog data voltage corresponding to the A value to the first data line at the second driving timing. However, since the area corresponding to the second driving timing is the transmissive area TA, it is not output through the subpixel SP since there is no subpixel in the first column OV1 and the second row OH2 of the optical area OA.

The reason why the data output unit 701 supplies the previous output data to the data driving circuit 130 is that since no subpixel SP is disposed in the transmissive area TA, it is not necessary to apply the data voltage Vdata corresponding to the transmissive area TA. Accordingly, it is possible to supply the data voltage Vdata and the output data which was output to the first row OH1, as it is, to the second row OH2 without a data transition.

At the third driving timing after the second driving timing, the data output unit 701 may receive current input data corresponding to the C value shown in the table of FIG. 10 from the host system 150. Further, the data output unit 701 may receive the previous output data, which corresponds to the B value output from the data output unit 701 at the second driving timing before the third driving timing, from the data buffer unit 702.

At the third driving timing when the subpixels SP disposed in the first column OV1 and the third row OH3 of the optical area OA are driven, the control signal output unit 710 may supply the first control signal CS1 to the data output unit 701 through pre-stored data.

When receiving the first control signal CS1 from the control signal output unit 710 at the third driving timing, the data output unit 701 may output current input data corresponding to the C value supplied from the host system 150 to the data driving circuit 130.

The data driving circuit 130 may supply the C′ value, which is an analog data voltage corresponding to the C value, to the subpixel SP disposed in the first column OV1 and third row OH3 through the first data line.

At the fourth driving timing after the third driving timing, the data output unit 701 may receive current input data corresponding to the D value shown in the table of FIG. 10 from the host system 150. Further, the data output unit 701 may receive the previous output data, which corresponds to the C value output from the data output unit 701 at the third driving timing before the fourth driving timing, from the data buffer unit 702.

At the fourth driving timing when the subpixels SP disposed in the first column OV1 and the fourth row OH4 of the optical area OA are driven, the control signal output unit 710 may supply the second control signal CS2 to the data output unit 701 through pre-stored data.

When receiving the second control signal CS2 from the control signal output unit 710 at the fourth driving timing, the data output unit 701 may output the previous output data corresponding to the C value received from the data buffer unit 702 to the data driving circuit 130.

The data driving circuit 130 may supply the C′ value which is an analog data voltage corresponding to the C value to the first data line at the fourth driving timing. However, since the area corresponding to the fourth driving timing is the transmissive area TA, it is not output through the subpixel SP.

The reason why the data output unit 701 supplies the previous output data to the data driving circuit 130 is that since no subpixel SP is disposed in the transmissive area TA at column O1 and row OH4, it is not necessary to apply the data voltage Vdata corresponding to the transmissive area TA. Accordingly, it is possible to supply the data voltage Vdata and the output data which was output to the third row OH3, as it is, to the fourth row OH4 without a data transition.

Meanwhile, the pattern of the subpixel SP and transmissive area TA disposed in the optical area OA is not limited to FIG. 1 and may be disposed in various ways.

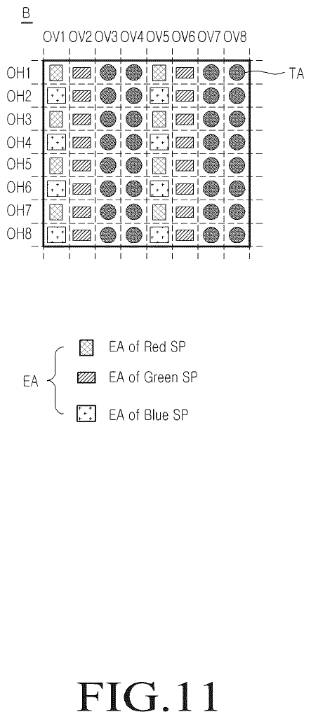

FIG. 11 is a view illustrating another arrangement of a subpixel SP and an emission area EA in area B of the optical area OA of FIG. 1 according to one embodiment.

Referring to FIG. 11, the optical area OA may be formed by repeating a pattern where the emission areas EA are disposed in two columns and the transmissive areas TA are disposed in the next two columns that is directly adjacent to the two columns of emission areas EA.

For example, emission areas EA may be disposed in the first column OV1 and the second column OV2. Transmissive areas TA may be disposed in the third column OV3 and the fourth column OV4.

The first data line, the second data line, and the subpixels SP disposed in the first column OV1 and the second column OV2 of the optical area OA illustrated in FIG. 11 may be driven in the same manner as the first column NV1 of the normal area NA illustrated in FIGS. 1 and 9.

In other words, the data voltage Vdata corresponding to the matrix coordinates of the display panel 110 may be supplied to each data line DL at the driving timing corresponding to the rows intersecting the first column OV1 and the second column OV2 of the optical area OA illustrated in FIG. 11.

Further, subpixels may not be disposed in the third and fourth data lines disposed in the third and fourth columns OV3 and OV4 of the optical area OA illustrated in FIG. 11. The third and fourth data lines disposed in the third and fourth columns OV3 and OV4 of the optical area OA may be driven in the same manner as the second and fourth rows OH2 and OH4 of the first column NV1 of the optical area OA illustrated in FIGS. 1 and 10 described above.

In other words, the data voltage Vdata of the previous driving timing may be supplied to each data line DL at driving timings corresponding to the rows intersecting the third and fourth columns OV3 and OV4 of the optical area OA illustrated in FIG. 11.

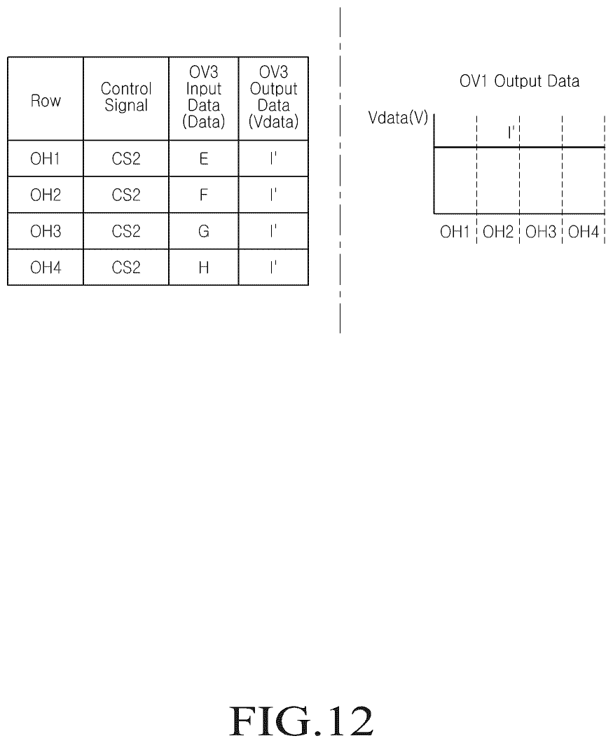

The input/output signals related to the driving of the third and fourth columns OV3 and OV4 of the optical area OA illustrated in FIG. 11 are described with reference to the table of FIG. 12.

FIG. 12 illustrates a table and a graph of input/output signals related to a third column OV3 in area B which is a portion of the optical area OA of FIG. 11 according to one embodiment.

Referring to FIGS. 11 and 12, the third data line may be disposed in the third column OV3 of the optical area OA. The subpixel SP may not be disposed in the third data line of the third column OV3 of the optical area OA, and the transmissive area TA may be disposed in each row.

As described above with reference to FIG. 7, at the driving timing corresponding to the row where the transmissive area TA is disposed, the data output unit 701 may receive the second control signal CS2 from the control signal output unit 710 and output the previous output data received from the data buffer unit 702 to the data driving circuit 130.

The data driving circuit 130 may supply the I′ value, which is an analog data voltage corresponding to the I value, to the third data line at the driving timing corresponding to each row. Therefore, even when different signals E, F, G, and H are input from the host system 150 at the driving timing of each row OH1, OH2, OH3, and OH4 where the transmissive area TA is disposed, the I′ value may be applied through the third data line.

Further, since the subpixel SP is not disposed in the third column OV3, but only the transmissive area TA is disposed, there is no output through the subpixel SP. In this case, the I value and the I′ value may be the same signal as the signal output at the previous driving timing of the third column OV3 and first row OH1 illustrated in FIG. 11. Therefore, unnecessary data transitions may be reduced, decreasing power consumption.

Further, the pattern of the subpixel SP and the transmissive area TA disposed in the optical area OA is not limited thereto.

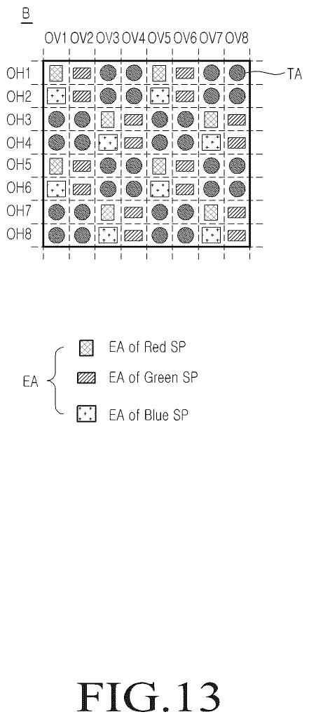

FIG. 13 is a view illustrating another arrangement of a subpixel SP and an emission area EA in area B of the optical area OA of FIG. 1.

Referring to FIG. 13, the optical area OA may be formed by repeating the pattern where subpixels SP disposed in units of two columns and two rows and transmissive areas TA disposed in units of two columns and two rows are alternately disposed.

For example, referring to FIG. 13, a subpixel SP may be disposed in the area where the first row OH1, the second row OH2, the first column OV1, and the second column OV2 intersect. Further, a transmissive area TA may be disposed in the area where the first row OH1, the second row OH2, the third column OV3, and the fourth column OV4 intersect.

Referring to FIG. 13, a transmissive area TA may be disposed in the area where the first row OH1, the second row OH2, the third column OV3, and the fourth column OV4 intersect. Further, a subpixel SP may be disposed in the area where the third row OH3, the fourth row OH4, the third column OV3, and the fourth column OV4 intersect. As such, in the optical area OA, the subpixel SP and the transmissive area TA disposed in units of two columns and two rows may be alternately disposed.

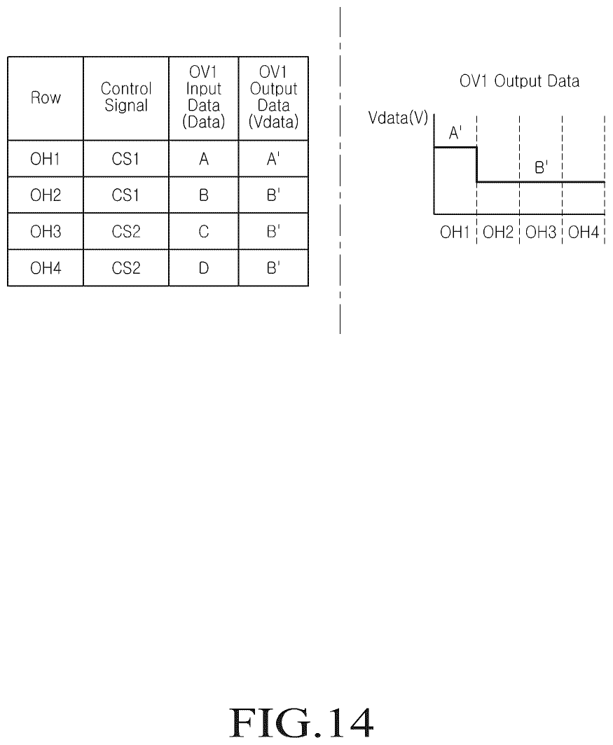

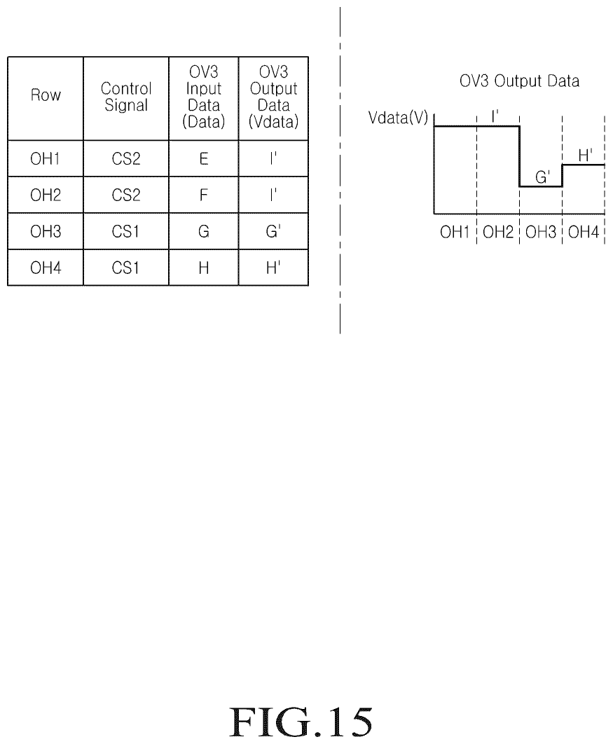

FIGS. 14 and 15 illustrate a table and a graph of input/output signals related to a first column OV1 and a third column OV3 in area B which is a portion of the optical area OA of FIG. 13.

Referring to FIGS. 13 and 14, the first data line may be disposed in the first column OV1 of the optical area OA. The subpixel SP may be disposed in the first row OH1 and the second row OH2 of the first column OV1 of the optical area OA. The transmissive area TA may be disposed in the third row OH3 and the fourth row OH4 of the first column OV1 of the optical area OA.

In the first row OH1 and the second row OH2 of the first column OV1, the data voltage Vdata corresponding to the matrix coordinates of the display panel 110 may be supplied to each data line DL at the driving timing corresponding to each row. The signal output at the previous driving timing may be supplied to the third row OH3 and fourth row OH4 of the first column OV1 at the driving timing corresponding to each row.

For example, current input data having the A value may be input from the host system 150 to the data output unit 701 at the driving timing corresponding to the first row OH1 of the first column OV1. Further, the previous output data having the A value output from the data output unit 701 at the previous driving timing from the data buffer unit 702 may be input to the data output unit 701. Further, the first control signal CS1 may be supplied from the control signal output unit 710. The data output unit 701 may supply output data having the A value to the data driving circuit 130. The data driving circuit 130 may supply the data voltage Vdata having the A′ value corresponding to the A value to the first data line.

Current input data having the B value may be input from the host system 150 to the data output unit 701 at the driving timing corresponding to the second row OH2 of the first column OV1. Further, the previous output data having the A value output from the data output unit 701 at the previous driving timing from the data buffer unit 702 may be input to the data output unit 701. Further, the first control signal CS1 may be supplied from the control signal output unit 710. The data output unit 701 may supply output data having the B value to the data driving circuit 130. The data driving circuit 130 may supply the data voltage Vdata having the B′ value corresponding to the B value to the first data line.

Current input data having the C value may be input from the host system 150 to the data output unit 701 at the driving timing corresponding to the third row OH3 of the first column OV1. Further, the previous output data having the B value output from the data output unit 701 at the previous driving timing from the data buffer unit 702 may be input to the data output unit 701. Further, the second control signal CS2 may be supplied from the control signal output unit 710. The data output unit 701 may supply output data having the B value to the data driving circuit 130. The data driving circuit 130 may supply the data voltage Vdata having the B′ value corresponding to the B value to the first data line.

Current input data having the D value may be input from the host system 150 to the data output unit 701 at the driving timing corresponding to the fourth row OH4 of the first column OV1. Further, the previous output data having the B value output from the data output unit 701 at the previous driving timing from the data buffer unit 702 may be input to the data output unit 701. Further, the second control signal CS2 may be supplied from the control signal output unit 710. The data output unit 701 may supply output data having the B value to the data driving circuit 130. The data driving circuit 130 may supply the data voltage Vdata having the B′ value corresponding to the B value to the first data line.

Referring to FIGS. 13 and 15, the third data line may be disposed in the third column OV3 of the optical area OA. The transmissive area TA may be disposed in the first row OH1 and the second row OH2 of the third column OV3 of the optical area OA. The subpixel SP may be disposed in the third row OH3 and the fourth row OH4 of the third column OV3 of the optical area OA.

The signal output at the previous driving timing may be supplied to the first row OH1 and second row OH2 of the third column OV3 at the driving timing corresponding to each row. In the third row OH3 and the fourth row OH4 of the third column OV3, the data voltage Vdata corresponding to the matrix coordinates of the display panel 110 may be supplied to each data line DL at the driving timing corresponding to each row.

For example, current input data having the E value may be input from the host system 150 to the data output unit 701 at the driving timing corresponding to the first row OH1 of the third column OV3. Further, the previous output data having the I value output from the data output unit 701 at the previous driving timing from the data buffer unit 702 may be input to the data output unit 701. Further, the second control signal CS2 may be supplied from the control signal output unit 710. The data output unit 701 may supply output data having the I value to the data driving circuit 130. The data driving circuit 130 may supply the data voltage Vdata having the I′ value corresponding to the I value to the third data line.

Current input data having the F value may be input from the host system 150 to the data output unit 701 at the driving timing corresponding to the second row OH2 of the third column OV3. Further, the previous output data having the I value output from the data output unit 701 at the previous driving timing from the data buffer unit 702 may be input to the data output unit 701. Further, the second control signal CS2 may be supplied from the control signal output unit 710. The data output unit 701 may supply output data having the I value to the data driving circuit 130. The data driving circuit 130 may supply the data voltage Vdata having the I′ value corresponding to the I value to the third data line.

Current input data having the G value may be input from the host system 150 to the data output unit 701 at the driving timing corresponding to the third row OH3 of the third column OV3. Further, the previous output data having the I value output from the data output unit 701 at the previous driving timing from the data buffer unit 702 may be input to the data output unit 701. Further, the first control signal CS1 may be supplied from the control signal output unit 710. The data output unit 701 may supply output data having the G value to the data driving circuit 130. The data driving circuit 130 may supply the data voltage Vdata having the G′ value corresponding to the G value to the third data line.

Current input data having the H value may be input from the host system 150 to the data output unit 701 at the driving timing corresponding to the fourth row OH4 of the third column OV3. Further, the previous output data having the A value output from the data output unit 701 at the previous driving timing from the data buffer unit 702 may be input to the data output unit 701. Further, the first control signal CS1 may be supplied from the control signal output unit 710. The data output unit 701 may supply output data having the B value to the data driving circuit 130. The data driving circuit 130 may supply the data voltage Vdata having the B′ value corresponding to the B value to the third data line.

In other words, referring to FIGS. 13, 14, and 15, as the signal of the previous driving timing is output at the driving timing of the matrix position where the transmissive area TA is disposed in the optical area OA, unnecessary data transitions may be reduced, thus decreasing power consumption.

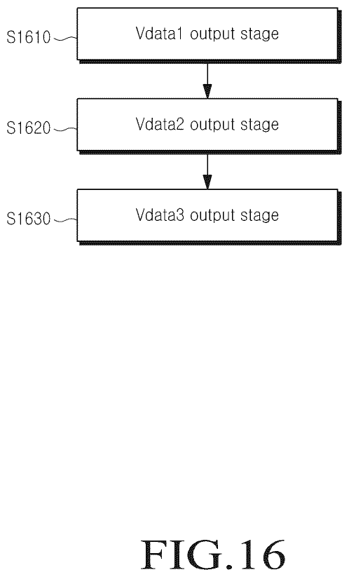

FIG. 16 is a flowchart illustrating a method for driving the first column OV1 of the optical area OA of FIG. 1 according to one embodiment.

The driving method of the display device 100 described in FIG. 16 illustrates part of the driving method of the entire display device 100, and may be a description of the driving method of the first row OH1, the second row OH2, and the third row OH3 of the first column OV1 of the optical area OA, and may also be applied to other embodiments of the disclosure.

Referring to FIG. 16, the method of driving the display device 100 of the first column OV1 of the optical area OA illustrated in FIG. 1 may include a first data voltage Vdata1 output step S1610, a second data voltage Vdata2 output step S1620, and a third data voltage Vdata3 output step S1630.

In this case, in the first data voltage Vdata1 output step S1610, the first data voltage Vdata1 may be applied to the subpixel SP of the first row OH1 where the first line is disposed through the first data line.

In the second data voltage Vdata2 output step S1620, the second data voltage Vdata2 may be applied to the first data line. In this case, the subpixel SP may not be disposed in the area where the first data line and the second line are connected, but the transmissive area TA may be disposed. Therefore, as described in the previous embodiments, the second data voltage Vdata2 may be the same signal as the first data voltage Vdata1 output in the first data voltage Vdata1 output step S1610.

In the third data voltage Vdata3 output step S1630, the third data voltage Vdata3 may be applied to the subpixel SP of the third row OH3 where the third line is disposed through the first data line.

As described in the second data voltage Vdata2 output step S1620, since the signal output in the second data voltage Vdata2 output step S1620 is the same signal as the signal output in the first data voltage Vdata1 output step S1610, no unnecessary data transition may occur, reducing the power consumption of the display device 100.

A display device according to an embodiment of the disclosure may be described as follows.

In one embodiment, a display device comprises: a display panel including a data line, a first subpixel and a second subpixel that are connected to the data line, and a first light transmissive area that is disposed along the data line, and a data driving circuit configured to output a first data voltage having a first voltage level to the first subpixel via the data line at a first driving timing that corresponds to the first subpixel and output a second data voltage that has the first voltage level to the data line at a second driving timing that corresponds to the first light transmissive area.

In one embodiment, the first voltage level is maintained at the second driving timing.

In one embodiment, the second data voltage is not applied to the first subpixel during the second driving timing.

In one embodiment, the data driving circuit is configured to output a third data voltage having a second voltage level that is different from the first voltage level to the second subpixel via the data line at a third driving timing that corresponds to the second subpixel, wherein the third driving timing is after the second driving timing which is after the first driving timing.

In one embodiment, the display panel further comprises a second light transmissive area that is disposed along the data line, wherein the data driving circuit is configured to output a fourth data voltage that maintains the second voltage level to the data line at a fourth driving timing that corresponds to the second light transmissive area, wherein the fourth driving timing is after the third driving timing.

In one embodiment, the first light transmissive area is disposed between the first subpixel and the second subpixel in a plan view of the display device and the second light transmissive area is disposed between the second subpixel and a third subpixel that is connected to the data line in the plan view.

In one embodiment, the first subpixel, the second subpixel, and the first light transmissive area are disposed in a second display area of the display panel that is at least partially surrounded by a first display area of the display panel that is less light transmissive than the second display area.

In one embodiment, the display device further comprises an optical electronic device that overlaps the second display area.

In one embodiment, a display device comprises a display panel including a data line, a first subpixel and a second subpixel that are connected to the data line, and a first light transmissive area that is disposed along the data line, a data driving circuit configured to output data voltages to the data line, and a timing controller configured to receive first input data and output first output data that is based on the first input data to the data driving circuit responsive to the first input data corresponding to the first subpixel, and receive second input data that is different from the first input data and output the first output data to the data driving circuit responsive to the second input data corresponding to the first light transmissive area.

In one embodiment, the data driving circuit is configured to receive the first input data and output a first data voltage having a first voltage level that is based on the first output data to the first subpixel via the data line at a first driving timing, and output a second data voltage that maintains the first voltage level to the data line at a second driving timing that corresponds to the first light transmissive area, wherein the second data voltage is not applied to the first subpixel at the second driving timing.

In one embodiment, the timing controller is configured to receive third input data and output third output data that is based on the third input data to the data driving circuit responsive to the third input data corresponding to the second subpixel, wherein the data driving circuit is configured to receive the third output data and output a third data voltage having a second voltage level that is different from the first voltage level to the second subpixel via the data line based on the third input data at a third driving timing.

In one embodiment, the display panel further comprises a second light transmissive area that is disposed along the data line, wherein the timing controller is further configured to receive fourth input data and output the third output data to the data driving circuit responsive to the fourth input data corresponding to the second light transmissive area, wherein the data driving circuit is configured to receive the third output data and output a fourth data voltage that maintains the second voltage level at a fourth driving timing that corresponds to the second light transmissive area.

In one embodiment, the first light transmissive area is disposed between the first subpixel and the second subpixel in a plan view of the display device and the second light transmissive area is disposed between the second subpixel and a third subpixel that is connected to the data line in the plan view.

In one embodiment, the timing controller comprises a control signal output circuit configured to output a first control signal responsive to the first input data corresponding to the first subpixel, a data output circuit configured to output the first output data that is based on the first input data responsive to receiving the first control signal from the control signal output circuit, and a data buffer circuit configured to store the first output data responsive to the data output circuit outputting the first output data.

In one embodiment, the control signal output circuit is configured to output a second control signal that is different from the first control signal responsive to the second input data corresponding to the first light transmissive area, the data buffer circuit is configured to output the first output data, and the data output circuit is configured to receive the first output data from the data buffer circuit and second input data that is different from the first input data, and output the first output data received from the data buffer circuit rather than second output data that is based on the second input data responsive to receiving the second control signal from the control signal output circuit.

In one embodiment, the first subpixel, the second subpixel, and the first light transmissive area are disposed in a second display area of the display panel that is at least partially surrounded by a first display area of the display panel that is less light transmissive than the second display area.

In one embodiment, the display device further comprises an optical electronic device that overlaps the second display area.

In one embodiment, a method for driving a display device comprising a data line, a first subpixel and a second subpixel that are connected to the data line, and a first light transmissive area that is disposed along the data line comprises outputting a first data voltage having a first voltage level to the first subpixel via the data line at a first driving timing that corresponds to the first subpixel, and outputting a second data voltage that maintains the first voltage level to the data line at a second driving timing that corresponds to the first light transmissive area, wherein the second data voltage is not output to the first subpixel during the second driving timing.

The above description has been presented to enable any person skilled in the art to make and use the technical idea of the disclosure, and has been provided in the context of a particular application and its requirements. Various modifications, additions and substitutions to the described embodiments will be readily apparent to those skilled in the art, and the general principles defined herein may be applied to other embodiments and applications without departing from the spirit and scope of the disclosure. The above description and the accompanying drawings provide an example of the technical idea of the disclosure for illustrative purposes only. That is, the disclosed embodiments are intended to illustrate the scope of the technical idea of the disclosure.

What is claimed is:

1. A display device, comprising:
a display panel including a data line, a first subpixel and a second subpixel that are connected to the data line, and a first light transmissive area that is disposed along the data line; and
a data driving circuit configured to output a first data voltage having a first voltage level to the first subpixel via the data line at a first driving timing that corresponds to the first subpixel and output a second data voltage that has the first voltage level to the data line at a second driving timing that corresponds to the first light transmissive area.

2. The display device of claim 1, wherein the first voltage level is maintained at the second driving timing.

3. The display device of claim 1, wherein the second data voltage is not applied to the first subpixel during the second driving timing.

4. The display device of claim 1, wherein the data driving circuit is configured to output a third data voltage having a second voltage level that is different from the first voltage level to the second subpixel via the data line at a third driving timing that corresponds to the second subpixel,
wherein the third driving timing is after the second driving timing which is after the first driving timing.

5. The display device of claim 4, wherein the display panel further comprises a second light transmissive area that is disposed along the data line,
wherein the data driving circuit is configured to output a fourth data voltage that maintains the second voltage level to the data line at a fourth driving timing that corresponds to the second light transmissive area,
wherein the fourth driving timing is after the third driving timing.

6. The display device of claim 5, wherein the first light transmissive area is disposed between the first subpixel and the second subpixel in a plan view of the display device and the second light transmissive area is disposed between the second subpixel and a third subpixel that is connected to the data line in the plan view.

7. The display device of claim 1, wherein the first subpixel, the second subpixel, and the first light transmissive area are disposed in a second display area of the display panel that is at least partially surrounded by a first display area of the display panel that is less light transmissive than the second display area.

8. The display device of claim 7, further comprising:
an optical electronic device that overlaps the second display area.

9. A display device, comprising:
a display panel including a data line, a first subpixel and a second subpixel that are connected to the data line, and a first light transmissive area that is disposed along the data line;
a data driving circuit configured to output data voltages to the data line; and
a timing controller configured to receive first input data and output first output data that is based on the first input data to the data driving circuit responsive to the first input data corresponding to the first subpixel, and receive second input data that is different from the first input data and output the first output data to the data driving circuit responsive to the second input data corresponding to the first light transmissive area.

10. The display device of claim 9, wherein the driving circuit is configured to receive the first input data and output a first data voltage having a first voltage level that is based on the first output data to the first subpixel via the data line at a first driving timing, and output a second data voltage that maintains the first voltage level to the data line at a second driving timing that corresponds to the first light transmissive area,
wherein the second data voltage is not applied to the first subpixel at the second driving timing.

11. The display device of claim 10, wherein the timing controller is configured to receive third input data and output third output data that is based on the third input data to the driving circuit responsive to the third input data corresponding to the second subpixel,
wherein the driving circuit is configured to receive the third output data and output a third data voltage having a second voltage level that is different from the first voltage level to the second subpixel via the data line based on the third input data at a third driving timing.

12. The display device of claim 11, wherein the display panel further comprises a second light transmissive area that is disposed along the data line,
wherein the timing controller is further configured to receive fourth input data and output the third output data to the driving circuit responsive to the fourth input data corresponding to the second light transmissive area,
wherein the driving circuit is configured to receive the third output data and output a fourth data voltage that maintains the second voltage level at a fourth driving timing that corresponds to the second light transmissive area.

13. The display device of claim 12, wherein the first light transmissive area is disposed between the first subpixel and the second subpixel in a plan view of the display device and the second light transmissive area is disposed between the second subpixel and a third subpixel that is connected to the data line in the plan view.

14. The display device of claim 9, wherein the timing controller comprises:
a control signal output circuit configured to output a first control signal responsive to the first input data corresponding to the first subpixel;
a data output circuit configured to output the first output data that is based on the first input data responsive to receiving the first control signal from the control signal output circuit; and
a data buffer circuit configured to store the first output data responsive to the data output circuit outputting the first output data.

15. The display device of claim 14, wherein:
the control signal output circuit is configured to output a second control signal that is different from the first control signal responsive to the second input data corresponding to the first light transmissive area,
the data buffer circuit is configured to output the first output data, and
the data output circuit is configured to receive the first output data from the data buffer circuit and second input data that is different from the first input data, and output the first output data received from the data buffer circuit rather than second output data that is based on the second input data responsive to receiving the second control signal from the control signal output circuit.

16. The display device of claim 9, wherein the first subpixel, the second subpixel, and the first light transmissive area are disposed in a second display area of the display panel that is at least partially surrounded by a first display area of the display panel that is less light transmissive than the second display area.

17. The display device of claim 16, further comprising:
an optical electronic device that overlaps the second display area.

18. A method for driving a display device comprising a data line, a first subpixel and a second subpixel that are connected to the data line, and a first light transmissive area that is disposed along the data line, the method comprising:
outputting a first data voltage having a first voltage level to the first subpixel via the data line at a first driving timing that corresponds to the first subpixel; and
outputting a second data voltage that maintains the first voltage level to the data line at a second driving timing that corresponds to the first light transmissive area,
wherein the second data voltage is not output to the first subpixel during the second driving timing.
